(19) United States
(12) Patent Application Publication
(10) Pub. No.: US 2016/0328685 A1
(43) Pub. Date: Nov. 10, 2016

(54) RESOURCE REALLOCATION METHOD AND SERVER

(71) Applicant: Tencent Technology (Shenzhen) Company Limited, Shenzhen, Guangdong (CN)

(72) Inventors: Wenxing WANG, Shenzhen, Guangdong (CN); Shanlin LI, Shenzhen, Guangdong (CN); Kan ZHANG, Shenzhen, Guangdong (CN); Jing GAO, Shenzhen, Guangdong (CN)

(21) Appl. No.: 15/108,536

(22) PCT Filed: Dec. 30, 2014
(86) PCT No.: PCT/CN2014/095703

§ 371 Date: Jun. 27, 2016

(30) Foreign Application Priority Data
Dec. 30, 2013 (CN) 201310743446.9

(51) Int. Cl. G06Q 20/10; G06Q 40/02

(52) U.S. Cl. CPC G06Q 20/10; G06Q 40/02

(57) ABSTRACT

A method and server for reallocating resources are provided. A resource reallocation instruction is received from a terminal corresponding to a user. The instruction carries first and second management platforms identifiers, a first amount of money for purchasing resources, and a first account identity registered by the user in the first management platform. A second account identity of the user in the second management platform is obtained, which corresponds to the second management platform identifier. The first amount of money is transferred from a resource management account to an account corresponding to the second account identity, and a request is made to the second management platform to allocate the resources to the account corresponding to the second account identity. A request is made to the first management platform to transfer the first amount of money from an account corresponding to the first account identity to the resource management account.

This application claims priority to Chinese Patent Application No. 201310743446.9 titled “METHOD, SERVER AND SYSTEM FOR REALLOCATING ACCOUNT RESOURCES” and filed with the Chinese State Intellectual Property Office on Dec. 30, 2013, which is incorporated herein by reference in its entirety.

### FIELD

The present disclosure relates to the field of Internet technology, and in particular to a method and a server for reallocating resources.

### BACKGROUND

Existing account management platforms do not support reallocation of resources among different accounts. For example, the resources may be funds, the account management platforms may be fund account management platforms and the reallocation of the resources among different accounts refers to transferring of fund account shares subscribed by a user among different accounts.

Generally, transferring of the subscribed fund account shares among different accounts is not supported in the fund account management platforms. Taking fund products of fund companies for example, if the user wants to switch funds (for example, the user is not satisfied with a certain fund company or profits therefrom), the user has to entirely redeem a fund and wait until the money in the fund is credited into account to purchase another fund. For example, if the user is not satisfied with a fund company, the user has to redeem money to his/her own bank card and then purchase a product of another fund company. In this way, the user has to run through the subscribing and redeeming processes, which results in complex operations for the user, and in addition, time of the user consumed in waiting is increased for the user can not subscribe a new fund product until the money of an original fund is credited into account.

### SUMMARY

A method and a server for reallocating resources are provided according to the present disclosure, to simplify operations of a user for reallocating resources in an account and reduce a waiting time of the user.

A method for reallocating resources is provided, which includes:

receiving a resource reallocation instruction from a terminal corresponding to a user, where the resource reallocation instruction carries an identifier of a first management platform, an identifier of a second management platform, a first amount of money required for purchasing resources and a first account identity registered by the user in the first management platform;

obtaining a second account identity of the user in the second management platform corresponding to the identifier of the second management platform;

transferring the first amount of money from a resource management account to an account corresponding to the second account identity, and requesting the second management platform to allocate the resources to the account corresponding to the second account identity based on the first amount of money; and

requesting the first management platform to transfer the first amount of money from an account corresponding to the first account identity to the resource management account based on the identifier of the first management platform.

A server is provided, which includes a receiver and a processor.

The receiver is configured to receive a resource reallocation instruction from a terminal corresponding to a user, where the resource reallocation instruction carries an identifier of a first management platform, an identifier of a second management platform, a first amount of money required for purchasing resources and a first account identity registered by the user in the first management platform; and

the processor is configured to obtain a second account identity of the user in the second management platform corresponding to the identifier of the second management platform, transfer the first amount of money from a resource management account to an account corresponding to the second account identity, request the second management platform to allocate the resources to the account corresponding to the second account identity based on the first amount of money, and request the first management platform to transfer the first amount of money from an account corresponding to the first account identity to the resource management account based on the identifier of the first management platform.

According to the present disclosure, once the user requests to redeem an amount of money from the first management platform and purchase resources in the second management platform, the amount of money is transferred from the resource management account to an account corresponding to the second management platform and the second management platform is requested to allocate the resources to the user. In this way, the user does not have to wait until the amount of money is redeemed from the first management platform, reducing a waiting time of the user, and in addition, the user only needs to request resource management platforms to reallocate resources without any other operation, simplifying operations for reallocating resources between different accounts.

A method for reallocating resources is provided according to the present disclosure, which includes:

obtaining, by a resource management server, a resource reallocation instruction from a user terminal, where the resource reallocation instruction includes information of reallocation of resources in an account registered by the user terminal in the resource management server among multiple platforms, where the multiple platforms include at least a first management platform and a second management platform and a predetermined quantity M of the resources in the account is allocated to the first management platform;

deducting a specified quantity N of resources from the first management platform according to the resource reallocation instruction based on the account of the user terminal, where N is not greater than M;

sending a payment instruction to a payment server, where the payment instruction includes paying a specified quantity of currencies from a payment account corresponding to the first management platform to a payment account corresponding to the second management platform, where the specified quantity of currencies matches the specified quantity N of resources; and

notifying, by the resource management server, the second management platform of a payment success after the payment server pays successfully, and adding, by the second management platform, in-account resources matching the specified quantity of currencies.

A server for reallocating resources is further provided according to the present disclosure, which includes:

an obtaining module, configured to obtain a resource reallocation instruction from a user terminal, where the resource reallocation instruction includes information of reallocation of resources in an account registered by the user terminal in a resource management server among multiple platforms, where the multiple platforms include at least a first management platform and a second management platform and a predetermined quantity M of the resources in the account is allocated to the first management platform;

a deducting module, configured to deduct a specified quantity N of resources from the first management platform according to the resource reallocation instruction based on the account of the user terminal, where N is not greater than M;

a requesting module, configured to send a payment instruction to a payment server, where the payment instruction includes paying a specified quantity of currencies from a payment account corresponding to the first management platform to a payment account corresponding to the second management platform, where the specified quantity of currencies matches the specified quantity N of resources; and

a notifying module, configured to notify the second management platform of a payment success after the payment server pays successfully, for the second management platform to add in-account resources matching the specified quantity of currencies.

A method for reallocating resources is further provided according to the present disclosure, which includes:

sending, by a user terminal, a resource reallocation instruction to a resource management server, where the resource reallocation instruction includes information of reallocation of resources in an account registered by the user terminal in the resource management server among multiple platforms, where the multiple platforms include at least a first management platform and a second management platform and a predetermined quantity M of the resources in the account is allocated to the first management platform;

receiving, by the resource management server, the resource reallocation instruction from the user terminal, and sending an account resource deduction instruction to the first management platform according to the resource reallocation instruction based on the account of the user terminal;

deducting, by the first management platform, a specified quantity N of resources according to the account resource deduction instruction, where N is not greater than M;

sending, by the resource management server, a payment instruction to a payment server, where the payment instruction includes paying a specified quantity of currencies from a payment account corresponding to the first management platform to a payment account corresponding to the second management platform, where the specified quantity of currencies matches the specified quantity N of resources;

notifying, by the resource management server, the second management platform of a payment success after the payment server pays successfully; and

adding, by the second management platform, resources matching the specified quantity of currencies to an account therein.

A system for reallocating resources is further provided according to the present disclosure, which includes a user terminal, a resource management server, a payment server and multiple platforms, where the multiple platforms include at least a first management platform and a second management platform.

The user terminal is configured to send a resource reallocation instruction to the resource management server, where the resource reallocation instruction includes information of reallocation of resources in an account registered by the user terminal in the resource management server between the multiple platforms and a predetermined quantity M of the resources in the account is allocated to the first management platform;

the resource management server is configured to obtain the resource reallocation instruction from the user terminal, and send an account resource deduction instruction to the first management platform according to the resource reallocation instruction based on the account of the user terminal;

the first management platform is configured to deduct a specified quantity N of resources, where N is not greater than M;

the resource management server is further configured to send a payment instruction to the payment server, where the payment instruction includes paying a specified quantity of currencies from a payment account corresponding to the first management platform to a payment account corresponding to the second management platform, where the specified quantity of currencies matches the specified quantity N of resources;

the payment server is configured to pay the specified quantity of currencies from the payment account corresponding to the first management platform to the payment account corresponding to the second management platform, where the specified quantity of currencies matches the specified quantity N of resources;

the resource management server is further configured to notify the second management platform of a payment success; and

the second management platform is configured to add resources matching the specified quantity of currencies to an account therein in response to notification information from the resource management server.

In the method, the server and the system for reallocating resources according to the present disclosure, the resource management server obtains the resource reallocation instruction from the user terminal, deducts the specified quantity of resources from the first management platform according to the resource reallocation instruction based on the account of the user terminal, sends the payment instruction to the payment server for the payment server to pay the specified quantity of currencies from the payment account corresponding to the first management platform to the payment account corresponding to the second management platform, where the specified quantity of currencies matches the specified quantity of resources, and notifies the second management platform of the payment success after the payment server pays successfully, for the second management platform to add the resources matching the specified quantity of currencies to the account therein. In this way, operations of the user for reallocating the resources in an account are simplified, the reallocation processed is performed in a real-time manner and a waiting time of the user in switching between accounts is reduced.

### BRIEF DESCRIPTION OF THE DRAWINGS

FIG. 1 is a flowchart of a method for reallocating resources according to a first embodiment of the invention;

FIG. 2-1 is a flowchart of a method for reallocating resources according to a second embodiment of the invention;

FIG. 2-2 is a schematic diagram of a resource reallocation interface according to the second embodiment of the invention;

FIG. 3-1 is a flowchart of a method for reallocating resources according to a third embodiment of the invention;

FIG. 3-2 is a schematic diagram of a resource reallocation interface according to the third embodiment of the invention;

FIG. 4-1 is a structural diagram of a first resource management platform according to a fourth embodiment of the invention;

FIG. 4-2 is a structural diagram of a second resource management platform according to the fourth embodiment of the invention;

FIG. 5 is a flowchart of a method for reallocating in-account resources between multiple management platforms according to an embodiment of the invention;

FIG. 6 is a schematic diagram of an operating interface for reallocating resources on a user terminal according to an embodiment of the invention;

FIG. 7 is a flowchart of a method for reallocating in-account resources between multiple management platforms according to an embodiment of the invention;

FIG. 8 is a flowchart of a method for reallocating in-account resources between multiple management platforms according to an embodiment of the invention;

FIG. 9 is a flowchart of a method for reallocating in-account resources among multiple management platforms according to an embodiment of the invention;

FIG. 10 is a schematic diagram of an interface in which a resource reallocation result is received by a user terminal according to an embodiment of the invention;

FIG. 11 is a flowchart of a method for reallocating in-account resources among multiple management platforms according to an embodiment of the invention;

FIG. 12 is a flowchart of a method for reallocating in-account resources among multiple management platforms according to an embodiment of the invention;

FIG. 13 is a flowchart of a method for reallocating in-account resources among multiple management platforms according to an embodiment of the invention;

FIG. 14 is a flowchart of a method for reallocating in-account resources among multiple management platforms according to an embodiment of the invention;

FIG. 15 is a flowchart of a method for reallocating in-account resources among multiple management platforms according to an embodiment of the invention;

FIG. 16 is a schematic diagram of functional modules in a resource management server for reallocating in-account resources among multiple management platforms according to an embodiment of the invention;

FIG. 17 is a schematic diagram of functional modules in a resource management server for reallocating in-account resources among multiple management platforms according to an embodiment of the invention;

FIG. 18 is a schematic diagram of functional modules in a resource management server for reallocating in-account resources among multiple management platforms according to an embodiment of the invention;

FIG. 19 is a structural diagram of a resource management server for reallocating in-account resources among multiple management platforms according to an embodiment of the invention; and

FIG. 20 is a schematic architecture diagram of a system for reallocating in-account resources among multiple management platforms according to an embodiment of the invention.

Detailed descriptions are made hereinafter in conjunction with the drawings so that the technical solutions according to the present disclosure may become clearer and more perspicuous.

### DETAILED DESCRIPTION

It should be understood that the specific embodiments described herein are merely used to explain the invention, rather than to limit the invention.

### First Embodiment

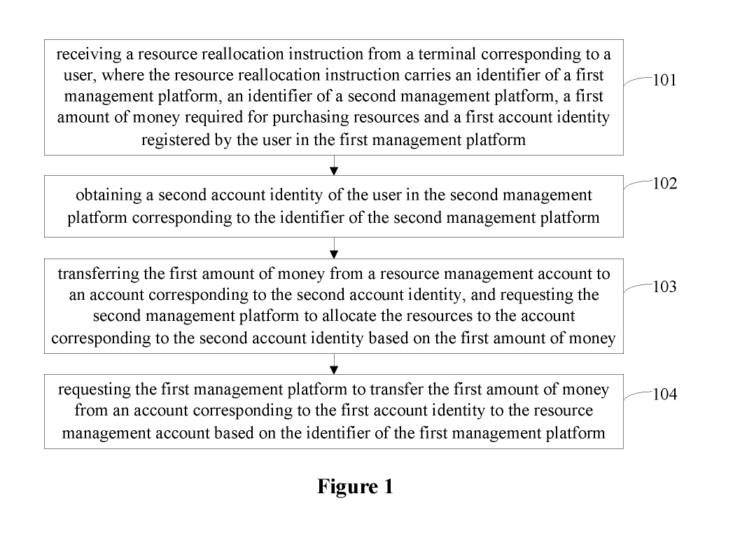

As shown in FIG. 1, a method for reallocating resources is provided according to an embodiment of the invention, which includes:

step 101, receiving a resource reallocation instruction from a terminal corresponding to a user, where the resource reallocation instruction carries an identifier of a first management platform, an identifier of a second management platform, a first amount of money required for purchasing resources and a first account identity registered by the user in the first management platform;

step 102, obtaining a second account identity of the user in the second management platform corresponding to the identifier of the second management platform;

step 103, transferring the first amount of money from a resource management account to an account corresponding to the second account identity, and requesting the second management platform to allocate the resources to the account corresponding to the second account identity based on the first amount of money; and

step 104, requesting the first management platform to transfer the first amount of money from an account corresponding to the first account identity to the resource management account based on the identifier of the first management platform.

In the embodiment of the invention, when the user requests to redeem some amount of money from the first management platform into the second management platform for purchasing resources, the amount of money is transferred from the resource management account to an account corresponding to the second management platform and the second management platform is requested to allocate the resources to the user. In this way, the user does not have to wait until the money is redeemed from the first management platform, reducing a waiting time of the user, and in addition, the user only needs to request resource management platforms to reallocate resources without any other operations, simplifying operations for reallocating resources between different accounts.

### Second Embodiment

A method for reallocating resources is provided according to an embodiment of the invention.

In the embodiment of the invention, a user registers a first account identity and a third account identity in a first management platform and a resource management platform in advance, respectively. An account corresponding to the first account identity includes resources the user purchases in advance, an account corresponding to the third account identity includes an amount of money owned by the user, and the first account identity and the third account identity are bound together in the resource management platform in advance. The first management platform may be a fund platform and the resource management platform may be embodied as a server.

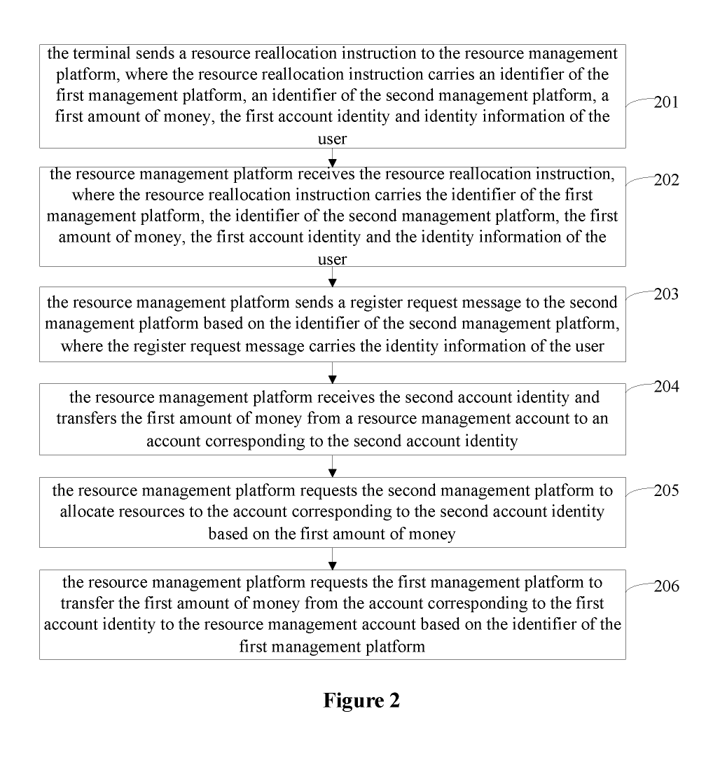

The user can request, through a terminal corresponding thereto, the resource management platform to redeem an amount of money, which corresponds to the resources the user purchases, from the first management platform into another management platform, for example, the second management platform, for purchasing resources, which is implemented as follows. As shown in FIG. 2-1, the method includes steps 201 to 206.

In step 201, the terminal sends a resource reallocation instruction to the resource management platform, where the resource reallocation instruction carries an identifier of the first management platform, an identifier of the second management platform, a first amount of money, the first account identity and identity information of the user.

The terminal may display the identifier of the first management platform, the first account identity, resources in the account corresponding to the first account identity and an amount of money corresponding to the resources on a resource reallocation interface.

If the user wants to redeem an amount of money corresponding to resources in the first management platform and register a new account identity in the second management platform to purchase resources, the user selects the identifier of the first management platform and the first account identity from which the redeem is to be performed, inputs the identifier of the second management platform and the identity information of the user, inputs the first amount of money based on a displayed amount in the resource reallocation interface, where the first amount as inputted is less than or equal to the displayed amount, and triggers the terminal. The terminal obtains the identifier of the first management platform, the first account identity, both of which are selected by the user, the identity information of the user inputted by the user, the identifier of the second management platform and the first amount of money, and generates the resource reallocation instruction carrying the identifier of the first management platform, the identifier of the second management platform, the identity information of the user, the first amount of money and the first account identity.

The account corresponding to the third account identity in the resource management platform may also include an amount of money owned by the user, and the terminal may as well obtain the amount of money in the account corresponding to the third account identity to be displayed on the resource reallocation interface. The user may purchase resources in the second management platform with the amount of money in the account corresponding to the third account identity, where a process thereof includes: the user inputs a second amount of money in the resource reallocation interface displayed on the terminal; and the terminal obtains the second amount of money, adds the second amount of money to the resource reallocation instruction to be sent to the resource management platform together, to request the resource management platform to purchase resources in the second management platform with the second amount of money in the account corresponding to the third account identity for the user.

For example, the resources are funds. Supposing an account corresponding to a first account identity IU1 of the user in the first management platform includes 5 funds and each fund in the first management platform values 2 dollars, an amount of money corresponding to the 5 funds is 10 dollars. It is assumed that the identifier of the first management platform is ID1, the third account identity registered by the user in the resource management platform is IU3 and the amount of money included in the account corresponding to the third account identity IU3 is 6 dollars. The terminal displays, on the resource reallocation interface as shown in FIG. 2-2, the identifier ID1 of the first management platform, the first account identity IU1, that the number of the funds included in the account corresponding to the first account identity IU1 is 5, that the amount of money corresponding to the 5 funds is 10 dollars and that the amount of money in the account corresponding to the third account identity IU3 is 6 dollars.

Thereafter the user can select the identifier ID1 of the first management platform, the first account identity IU1, input identity information Ueser of the user, the identifier ID2 of the second management platform, the first amount 10 dollars and the second amount 5 dollars, in the resource reallocation interface as shown in FIG. 2-2, and tap a confirm button to send a command to the terminal. The terminal receives the command, obtains the identifier ID1 of the first management platform, the first account identity IU1, both of which are selected by the user, the identity information Ueser inputted by the user, the identifier ID2 of the second management platform, the first amount 10 dollars and the second amount 5 dollars from the resource reallocation interface as shown in FIG. 2-2, generates a resource reallocation instruction carrying the identifier ID1 of the first management platform, the first account identity IU1, the identity information Ueser, the identifier ID2 of the second management platform, the first amount 10 dollars and the second amount 5 dollars and sends the resource reallocation instruction to the resource management platform.

In step 202, the resource management platform receives the resource reallocation instruction, where the resource reallocation instruction carries the identifier of the first management platform, the identifier of the second management platform, the first amount of money, the first account identity and the identity information of the user.

For example, the resource management platform receives the resource reallocation instruction, where the resource reallocation instruction carries the identifier ID1 of the first management platform, the first account identity IU1, the identity information Ueser and the identifier ID2 of the second management platform.

In step 203, the resource management platform sends a register request message to the second management platform based on the identifier of the second management platform, where the register request message carries the identity information of the user.

The second management platform receives the register request message from the resource management platform, registers a second account identity for the user based on the identity information of the user carried in the register request message, and sends the second account identity to the resource management platform.

For example, the resource management platform sends a register request message to the second management platform based on the identifier ID2 of the second management platform, where the register request message carries the identity information Ueser of the user. The second management platform receives the register request message, registers a second account identity IU2 based on the identity information Ueser of the user carried in the register request message, and sends the second account identity IU2 to the resource management platform.

In step 204, the resource management platform receives the second account identity and transfers the first amount of money from a resource management account to an account corresponding to the second account identity.

The resource management account is a public account in the resource management platform. If the resource reallocation instruction further carries the second amount of money, the resource management platform can transfer the second amount of money from the account corresponding to the third account identity to the account corresponding to the second account identity.

For example, after receiving the second account identity IU2, the resource management platform deducts the first amount 10 dollars from the resource management account, adds the first amount 10 dollars to the account corresponding to the second account identity, obtains the third account identity IU3 bound with the first account identity IU1, deducts the second amount 5 dollars from the account corresponding to the third account identity IU3 and adds the second amount 5 dollars to the account corresponding to the second account identity.

In step 205, the resource management platform requests the second management platform to allocate resources to the account corresponding to the second account identity based on the first amount of money.

To be specific, the resource management platform sends a resource allocation request to the second management platform based on the identifier of the second management platform, where the resource allocation request carries a transfer instruction, the first amount of money and the second account identity, where the transfer instruction is used to indicate a successful transfer of the first amount of money from the resource management account to the account corresponding to the second account identity. The second management platform receives the resource allocation request, determines that the first amount of money has been transferred to the account corresponding to the second account identity according to the transfer instruction and allocates resources corresponding to the first amount of money to the account corresponding to the second account identity based on the first amount of money.

Further, if the resource reallocation instruction further carries the second amount of money, the resource allocation request from the resource management platform further carries the second amount of money, and the second management platform further allocates resources corresponding to the second amount of money to the account corresponding to the second account identity based on the second amount of money.

For example, the resource management platform sends a resource allocation request to the second management platform based on the identifier ID2 of the second management platform, where the resource allocation request carries a transfer instruction, the first amount 10 dollars, the second amount 5 dollars and the second account identity IU2. The second management platform receives the resource allocation request, and allocates funds corresponding to an amount 15 dollars to the account corresponding to the second account identity based on the transfer instruction, the first amount 10 dollars and the second amount 5 dollars. Supposing in the second management platform each fund values 1 dollar, 15 funds are allocated to the account corresponding to the second account identity.

In step 206, the resource management platform requests the first management platform to transfer the first amount of money from the account corresponding to the first account identity to the resource management account based on the identifier of the first management platform.

To be specific, the step above may be implemented through the process including steps (1) to (4).

In step (1), the resource management platform obtains the third account identity bound with the first account identity and monitors the account corresponding to the third account identity.

In step (2), the resource management platform sends a deduction request to the first management platform based on the identifier of the first management platform, where the deduction request carries the first amount of money and the first account identity, keeps monitoring the account corresponding to the third account identity and waits.

In step (3), the first management platform deducts the first amount of money from the account corresponding to the first account identity according to the first amount of money, deducts resources corresponding to the first amount of money from the account corresponding to the first account identity, and transfers the first amount of money from the account corresponding to the first account identity to the account corresponding to the third account identity after the deducting is completed.

In step (4), the resource management platform transfers the first amount of money from the account corresponding to the third account identity to the resource management account on detecting that the first management platform transfers the first amount of money to the account corresponding to the third account identity.

For example, the resource management platform obtains the third account identity IU3 bound with the first account identity IU1, monitors the account corresponding to the third account identity IU3, sends a deduction request to the first management platform based on the identifier ID1 of the first management platform, where the deduction request carries the first amount 10 dollars and the first account identity IU1, keeps monitoring the account corresponding to the third account identity IU3 and waits. The first management platform deducts resources corresponding to the first amount 10 dollars from the account corresponding to the first account identity IU1 based on the first amount 10 dollars, and transfers the first amount 10 dollars from the account corresponding to the first account identity IU1 to the account corresponding to the third account identity IU3 after the deducting is completed. The resource management platform transfers the first amount 10 dollars from the account corresponding to the third account identity IU3 to the resource management account on detecting that the first management platform transfers the first amount 10 dollars to the account corresponding to the third account identity IU3.

In the embodiment of the invention, once the user requests to redeem an amount of money from the first management platform and purchase resources in the second management platform, the resource management platform first transfers the amount of money from the resource management account to the account corresponding to the second account identity, and requests the second management platform to allocate resources for the user. In this way, the user does not have to wait until the amount of money is redeemed from the first management platform, reducing a waiting time of the user.

### Third Embodiment

A method for reallocating resources is provided according to an embodiment of the invention.

In the embodiment of the invention, a user registers, in advance, a first account identity, a second account identity and a third account identity in a first management platform, a second management platform and a resource management platform, respectively. An account corresponding the first account identity includes resources the user obtains in advance, an account corresponding to the third account identity includes an amount of money owned by the user. The first account identity and the third account identity are bound in advance in the resource management platform, so are the second account identity and the third account identity. Each of the first management platform and the second management platform may be a fund platform, and the resource management platform may be a server.

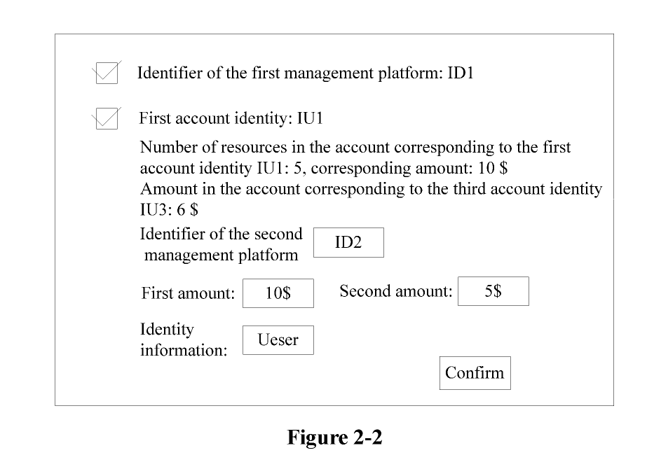

The user can request, through a terminal corresponding thereto, the resource management platform to redeem an amount of money, which corresponds to the resources the user purchases, from the first management platform, and purchase resources in the second management platform, which is implemented as follows. As shown in FIG. 3-1, the method includes steps 301 to 305.

In step 301, the terminal sends a resource reallocation instruction to the resource management platform, where the resource reallocation instruction carries an identifier of the first management platform, an identifier of the second management platform, a first amount of money, the first account identity and the second account identity.

The terminal may display the identifier of the first management platform, the first account identity, the identifier of the second management platform, the second account identity, resources in the account corresponding to the first account identity and an amount of money corresponding to the resources on a resource reallocation interface.

If the user wants to redeem an amount of money corresponding to resources from the first management platform and purchase resources in the second management platform, the user selects the identifier of the first management platform and the first account identity from which the redeem is to be performed, the identifier of the second management platform in which the resources are to be purchased and the second account identity, inputs the first amount of money based on a displayed amount in the resource reallocation interface, where the first amount of money as inputted is less than or equal to the displayed amount of money, and triggers the terminal. The terminal obtains the identifier of the first management platform, the first account identity, the identifier of the second management platform, the second account identity, all of which are selected by the user, and the first amount of money inputted by the user, and generates the resource reallocation instruction carrying the identifier of the first management platform, the identifier of the second management platform, the first amount of money, the second account identity and the first account identity.

The account corresponding to the third account identity in the resource management platform may also include an amount of money owned by the user, and the terminal may as well obtain the amount of money in the account corresponding to the third account identity and display the same on the resource reallocation interface. The user may purchase resources in the second management platform with the amount of money in the account corresponding to the third account identity, where a process thereof includes: the user inputs a second amount of money in the resource reallocation interface displayed on the terminal; and the terminal obtains the second amount of money, adds the second amount of money to the resource reallocation instruction and sends them to the resource management platform together, to request the resource management platform to purchase resources in the second management platform with the second amount of money in the account corresponding to the third account identity for the user.

For example, the resources are funds. Supposing the account corresponding to a first account identity IU1 of the user includes 5 funds and each fund in the first management platform values 2 dollars, an amount of money corresponding to the 5 funds is 10 dollars. It is assumed that the identifier of the first management platform is ID1, the third account identity registered by the user in the resource management platform is IU3 and the amount of money included in the account corresponding to the third account identity IU3 is 6 dollars. The terminal displays, on the resource reallocation interface as shown in FIG. 3-2, the identifier ID1 of the first management platform, the identifier ID2 of the second management platform, the first account identity IU1, the second account identity IU2, that the number of the funds included in the account corresponding to the first account identity IU1 is 5, that the amount of money corresponding to the 5 funds is 10 dollars and that the amount of money in the account corresponding to the third account identity IU3 is 6 dollars.

Thereafter the user can select, on the resource reallocation interface as shown in FIG. 3-2, the identifier ID1 of the first management platform, the first account identity IU1, the identifier ID2 of the second management platform and the second account identity IU2, input the first amount 10 dollars and the second amount 5 dollars, and tap a confirm button to send a command to the terminal. The terminal receives the command, obtains the identifier ID1 of the first management platform, the first account identity IU1, the identifier ID2 of the second management platform, the second account identity IU2, all of which are selected by the user, the first amount 10 dollars and the second amount 5 dollars, both of which are inputted by the user, from the resource reallocation interface as shown in FIG. 3-2, generates a resource reallocation instruction carrying the identifier ID1 of the first management platform, the first account identity IU1, the identifier ID2 of the second management platform, the second account identity IU2, the first amount 10 dollars and the second amount 5 dollars and sends the resource reallocation instruction to the resource management platform.

In step 302, the resource management platform receives the resource reallocation instruction, where the resource reallocation instruction carries the identifier of the first management platform, the identifier of the second management platform, the first amount of money, the first account identity and the second account identity.

For example, the resource management platform receives the resource reallocation instruction, where the resource reallocation instruction carries the identifier ID1 of the first management platform, the first account identity IU1, the identifier ID2 of the second management platform, the second account identity IU2, the first amount 10 dollars and the second amount 5 dollars

In step 303, the resource management platform transfers the first amount of money from a resource management account to an account corresponding to the second account identity.

The resource management account is a public account in the resource management platform.

In the step, the resource management platform may send a first payment instruction to a payment server, where the first payment instruction carries a resource management account identity, the first amount of money and the second account identity. The payment server receives the first payment instruction, deducts the first amount of money from the resource management account corresponding to the resource management account identity, adds the first amount of money to the account corresponding to the second account identity and sends a payment completion message to the resource management platform. The resource management platform receives the payment completion message and determines that the first amount of money is successfully transferred from the resource management account to the account corresponding to the second account identity according to the payment completion message.

If the resource reallocation instruction further carries the second amount of money, the resource management platform can transfer the second amount of money from the account corresponding to the third account identity to the account corresponding to the second account identity.

To be specific, the resource management platform obtains the third account identity bound with the first account identity, and sends a second payment instruction to the payment server, where the second payment instruction carries the third account identity, the second amount of money and the second account identity. The payment server receives the second payment instruction, deducts the second amount of money from the account corresponding to the third account identity, adds the second amount of money to the account corresponding to the second account identity, and sends the payment completion message to the resource management platform. The resource management platform receives the payment completion message, and determines that the second amount of money is successfully transferred from the account corresponding to the third account identity to the account corresponding to the second account identity according to the payment completion message.

For example, the resource management platforms sends the first payment instruction to the payment server, where the first payment instruction carries a resource management account identity IU4, the first amount 10 dollars and the second account identity IU2. The payment server receives the first payment instruction, deducts the first amount 10 dollars from the resource management account corresponding to the resource management account identity IU4, adds the first amount 10 dollars to the account corresponding to the second account identity, and sends a payment completion message to the resource management platform. The resource management platform receives the payment completion message, and determines that the first amount 10 dollars is successfully transferred from the resource management account to the account corresponding to the second account identity according to the payment completion message.

Thereafter, the resource management platform obtains the third account identity IU3 bound with the first account identity IU1, sends a second payment instruction to the payment server, where the second payment instruction carries the third account identity IU3, the second amount 5 dollars and the second account identity IU2. The payment server receives the second payment instruction, deducts the second amount 5 dollars from the account corresponding to the third account identity IU3, adds the second amount 5 dollars to the account corresponding to the second account identity, and sends a payment completion message to the resource management platform. The resource management platform receives the payment completion message, and determines that the second amount 5 dollars is successfully transferred from the account corresponding to the third account identity IU3 to the account corresponding to the second account identity according to the payment completion message.

In step 304, the resource management platform requests the second management platform to allocate resources to the account corresponding to the second account identity according to the first amount.

To be specific, the resource management platform sends a resource allocation request to the second management platform based on the identifier of the second management platform, where the resource allocation request carries a transfer instruction, the first amount of money and the second account identity, where the transfer instruction is used to indicate that the first amount of money is successfully transferred from an account corresponding to the resource management platform to an account corresponding to second management platform. The second management platform receives the resource allocation request, and allocates resources corresponding to the first amount of money to the account corresponding to the second account identity according to the transfer instruction and the first amount of money.

Further, if the resource reallocation instruction further carries the second amount of money, the resource allocation request from the resource management platform further carries the second amount of money, and the second management platform further allocates resources corresponding to the second amount of money to the account corresponding to the second account identity.

For example, the resource management platform sends a resource allocation request to the second management platform based on the identifier ID2 of the second management platform, where the resource allocation request carries a transfer instruction, the first amount 10 dollars, the second amount 5 dollars and the second account identity IU2. The second management platform receives the resource allocation request, and allocates funds corresponding to an amount 15 dollars to the account corresponding to the second account identity according to the transfer instruction, the first amount 10 dollars and the second amount 5 dollars. Supposing in the second management platform each fund values 1 dollar, 15 funds are allocated to the account corresponding to the second account identity.

In step 305, the resource management platform requests the first management platform to transfer the first amount of money from the account corresponding to the first account identity to the resource management account based on the identifier of the first management platform.

To be specific, the step above may be implemented through the process including steps (1) to (4).

In step (1), the resource management platform obtains the third account identity bound with the first account identity and monitors the account corresponding to the third account identity.

In step (2), the resource management platform sends a deduction request to the first management platform based on the identifier of the first management platform, where the deduction request carries the first amount of money and the first account identity, and keeps monitoring the account corresponding to the third account identity.

In step (3), the first management platform deducts the resources corresponding to the first amount of money from the account corresponding to the first account identity based on the first amount of money, and transfers the first amount of money from the account corresponding to the first account identity to the account corresponding to the third account identity after the deducting is completed.

In step (4), the resource management platform transfers the first amount of money from the account corresponding to the third account identity to the resource management account on detecting that the first management platform transfers the first amount of money to the account corresponding to the third account identity.

For example, the resource management platform obtains the third account identity IU3 bound with the first account identity IU1, monitors the account corresponding to the third account identity IU3, sends a deduction request to the first management platform based on the identifier ID1 of the first management platform, where the deduction request carries the first amount 10 dollars and the first account identity IU1, keeps monitoring the account corresponding to the third account identity IU3 and waits. The first management platform deducts resources corresponding to the first amount 10 dollars from the account corresponding to the first account identity IU1 based on the first amount 10 dollars, and transfers the first amount 10 dollars from the account corresponding to the first account identity IU1 to the account corresponding to the third account identity IU3 after the deducting is completed. The resource management platform transfers the first amount 10 dollars from the account corresponding to the third account identity IU3 to the resource management account on detecting that the first management platform transfers the first amount 10 dollars to the account corresponding to the third account identity IU3.

In the embodiment of the invention, once the user requests to redeem an amount of money from the first management platform and purchase resources in the second management platform, the resource management platform first transfers the amount of money from the resource management account to the account corresponding to the second account identity, and requests the second management platform to allocate resources for the user. In this way, the user does not have to wait until the amount of money is redeemed from the first management platform, reducing a waiting time of the user.

### Fourth Embodiment

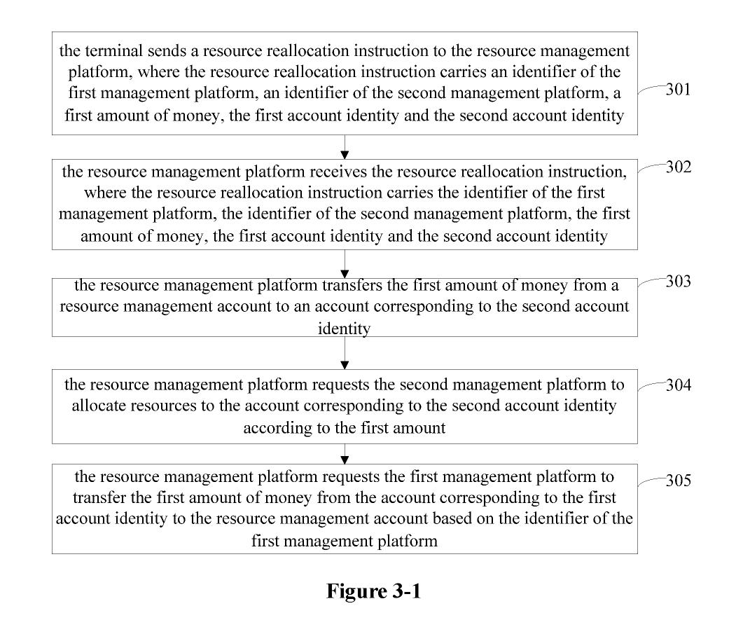

As shown in FIG. 4-1, a server is provided according to an embodiment of the invention, which includes a receiver 401 and a processor 402.

The receiver 401 is configured to receive a resource reallocation instruction from a terminal corresponding to a user, where the resource reallocation instruction carries an identifier of a first management platform, an identifier of a second management platform, a first amount of money required for purchasing resources and a first account identity registered by the user in the first management platform.

The processor 402 is configured to obtain a second account identity of the user in the second management platform corresponding to the identifier of the second management platform, transfer the first amount of money from a resource management account to an account corresponding to the second account identity, request the second management platform to allocate the resources to the account corresponding to the second account identity based on the first amount of money, and request the first management platform to transfer the first amount of money from an account corresponding to the first account identity to the resource management account based on the identifier of the first management platform.

Further, as shown in FIG. 4-2, the server further includes a receiver 403.

When the processor 402 is configured to perform request the first management platform to transfer the first amount of money from the account corresponding to the first account identity to the resource management account based on the identifier of the first management platform,

the processor 402 is configured to obtain a third account identity bound with the first account identity and monitor an account corresponding to the third account identity, where the third account identity is registered by the user in a resource management platform;

the transmitter 403 is configured to send a deduction request to the first management platform based on the identifier of the first management platform, where the deduction request carries the first amount of money and the first account identity, for the first management platform to deduct the first amount of money from the account corresponding to the first account identity and transfer the first amount of money from the account corresponding to the first account identity to the account corresponding to the third account identity after the deducting is completed; and

the processor 402 is further configured to transfer the first amount of money from the account corresponding to the third account identity to an account corresponding to the resource server on detecting that the first management platform transfers the first amount of money to the account corresponding to the third account identity.

Further, the resource reallocation instruction further carries a second amount of money required for purchasing resources.

The processor 402 is further configured to transfer the second amount of money from the account corresponding to the third account identity to the account corresponding to the second account identity, and request the second management platform to allocate the resources to the account corresponding to the second account identity based on the second amount of money.

When the processor 402 is configured to request the second management platform to allocate the resources to the account corresponding to the second account identity based on the first amount of money, the processor 402 is configured to:

trigger the transmitter 403 to send a resource allocation request to the second management platform, where the resource allocation request carries a transfer instruction and the second account identity, where the transfer instruction is used to indicate that the first amount of money is successfully transferred from the resource management account to the account corresponding to the second account identity, for the second management platform to allocate the resources to the account corresponding to the second account identity based on the first amount of money on receiving the transfer instruction.

The resource reallocation instruction further carries identity information of the user, and the resource management platform further includes a transmitter.

When the processor 402 is configured to obtain the second account identity registered by the user in the second management platform corresponding to the identifier of the second management platform,

the processor 402 is configured to trigger the transmitter to send a register request message to the second management platform based on the identifier of the second management platform, where the register request message carries the identity information of the user, for the second management platform to register the second account identity based on the identity information of the user; and

the receiver 403 is further configured to receive the second account identity from the second management platform.

In the embodiment of the invention, once the user requests to redeem an amount of money from the first management platform and purchase resources in the second management platform, the resource management platform first transfers the amount of money from the resource management account to the account corresponding to the second account identity, and requests the second management platform to allocate resources for the user. In this way, the user does not have to wait until the amount of money is redeemed from the first management platform, reducing a waiting time of the user.

A main technical solution according to the present disclosure is described as follows. A resource management server obtains a resource reallocation instruction from a user terminal, deducts a specified quantity of resources from a first management platform according to the resource reallocation instruction based on an account of the user terminal, sends a payment instruction to a payment server; the payment server pays a specified quantity of currencies from a payment account corresponding to the first management platform to a payment account corresponding to a second management platform, where the specified quantity of currencies matches the specified quantity of resources; the resource management server notifies the second management platform of a payment success after the payment server pays successfully; the second management platform adds in-account resources matching the specified quantity of currencies. In this way, operations of a user for reallocating resources in an account are simplified, the transferring process is performed in a real-time manner, and a waiting time of the user in switching between accounts is reduced.

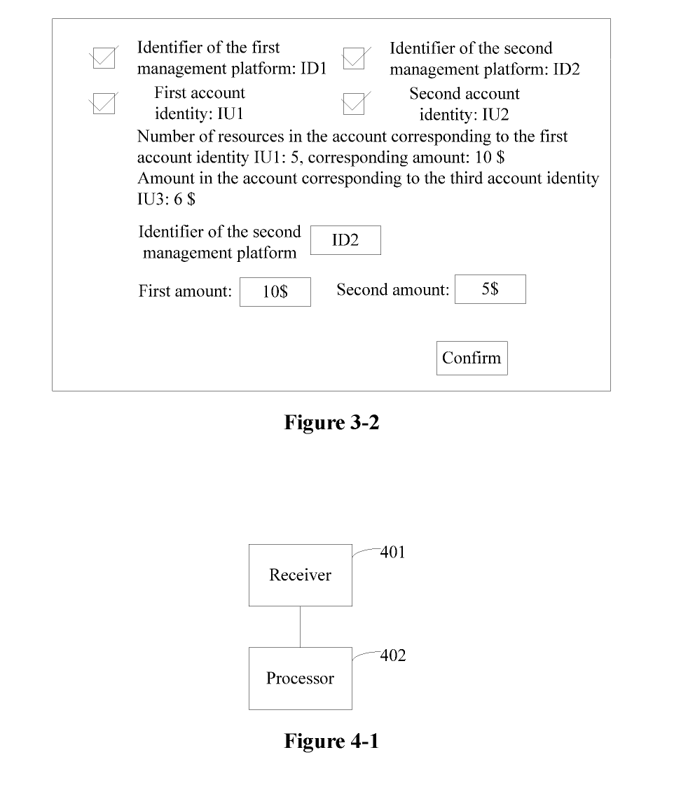

As shown in FIG. 5, a method for reallocating in-account resources among multiple management platforms is provided according to an embodiment of the invention, which includes steps S101 to S104.

In step S101, a resource management server obtains a resource reallocation instruction from a user terminal, where the resource reallocation instruction includes information of reallocation of resources in an account registered by the user terminal in the resource management server among multiple platforms, where the multiple platforms include at least a first management platform and a second management platform and a predetermined quantity M of the resources in the account is allocated to the first management platform.

An implementation environment of the method according to the embodiment of the invention involves a user terminal, a resource management server, a payment server and multiple management platforms, where the first management platform and the second management platform are taken for example in the embodiment.

The user terminal may include, but not limited to, Personal Computer (PC) or mobile device such as smart phone (such as Android phone or iOS phone), tablet computer, palm computer, mobile internet device (MID) or PAD. The user terminal is installed with account operating application software (for example, fund software).

The resource management server is a server for managing allocation of resources in user account among different management platforms.

The payment server, as a background server of the resource management server, implements specific payment services in the allocation of resources in the user account.

The multiple management platforms are each configured to manage for themselves operations such as opening accounts, subscribing shares for accounts, transacting between accounts and redeeming shares in accounts. For example, in a case of fund products, the multiple management platforms may be fund product management platforms corresponding to different fund companies, or different account management platforms in a same fund company.

Existing account management platforms generally do not support transferring of shares subscribed by a user between accounts. Taking fund products of fund companies for example, if the user wants to switch between funds, the user has to entirely redeem a fund and purchase other funds (including other funds of a current fund company and funds of other fund companies) after money in the fund is credited into account. The user has to perform the subscribing and redeeming processes, which results in a complex operating process for reallocating resources of the user, and in addition, a waiting time of the user is increased for the user can not subscribe a new fund product until the money of the original fund is credited into account.

In the embodiment, a flexible choice among different management platforms can be achieved for the user, and the resource reallocation process can be simplified. In addition, the resource reallocation process is performed in a real-time manner and a waiting time of the user in switching between accounts is reduced

To be specific, once the user chooses to transfer resources in one management platform to another, for example, reallocate resources in the first management platform to the second management platform, the user sends the resource reallocation instruction to the resource management server through the user terminal.

The resource reallocation instruction includes information of reallocation of resources, in the account registered by the user terminal in the resource management server, between the first management platform and the second management platform, i.e., includes account information of the user in the first management platform, and the specified quantity M of the resources, which the user allocates to the first management platform. Besides, it is presumed in the embodiment that the user has a new account in the second management platform.

Taking fund account management platforms for example, if the user chooses a new fund company and needs to transfer shares in an account in an original account management platform to a new account management platform, the user terminal sends a resource reallocation instruction to the resource management server, where the resource reallocation instruction carries information such as names of the original account management platform and the new account management platform, the subscribing account of the user in the original account management platform and the shares in the account.

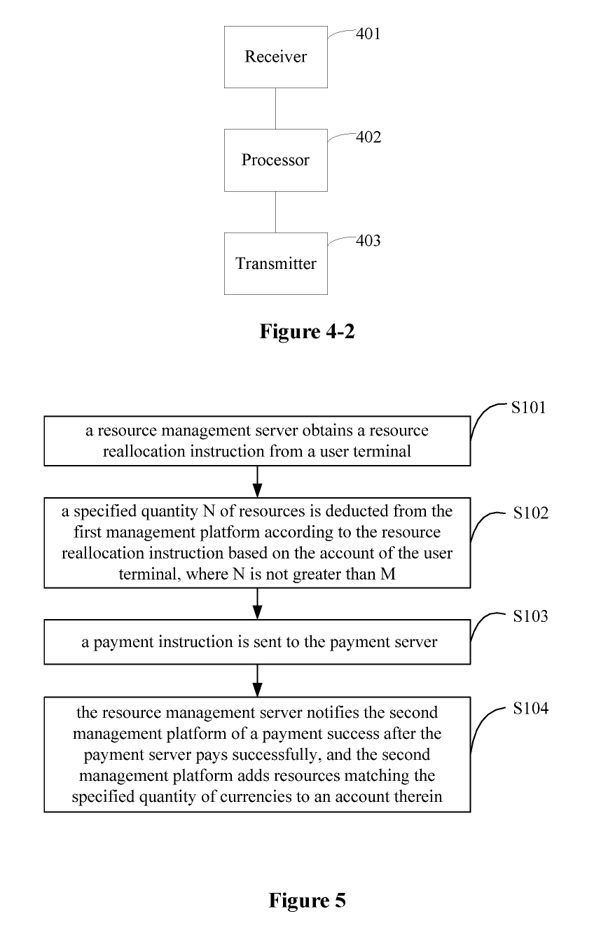

The resource management server may provide an operating interface for the user to choose, as is shown in FIG. 6. When selecting the new account management platform and requesting a resource reallocation, the user is prompted for a confirmation, and if the user taps a confirm button, subsequent resource reallocating and transferring operations are performed.

In step S102, a specified quantity N of resources is deducted from the first management platform according to the resource reallocation instruction based on the account of the user terminal, where N is not greater than M.

After receiving the resource reallocation instruction from the user terminal, the resource management server deducts the specified quantity N of resources from the first management platform based on the account of the user terminal in the resource management server, where N is not greater than M (the quantity of resources the user allocates to the first management platform). To facilitate the deducting operation of the resource management server, the resource management server may bond an account registered by the user in the resource management server and a subscribing account of the user in the first management platform in advance.

Taking fund account management platforms for example, after receiving the resource allocation instruction from the user terminal, the resource management server needs to complete switching between transaction accounts of the user and redeems shares in an original account from the original account management platform (the first management platform), where the shares in the original account is obtained from the resource allocation instruction from the user terminal.

The resource management server sends a redemption request for the shares in the original account to the original account management platform, and the original account management platform deducts the shares in the original account of the user in response to the redemption request from the resource management server.

In step S103, a payment instruction is sent to the payment server, where the payment instruction includes paying a specified quantity of currencies from a payment account corresponding to the first management platform to a payment account corresponding to the second management platform, where the specified quantity of currencies matches the specified quantity N of resources.

After deducting the specified quantity N of resources from the first management platform according to the resource reallocation instruction from the user terminal, the resource management server notifies the payment server to perform a payment operation. The payment server pays the specified quantity of currencies from the payment account corresponding to the first management platform to the payment account corresponding to the second management platform according to a payment instruction of the resource management server, where the specified quantity of currencies matches the specified quantity N of resources deducted by the resource management server.

After completing the payment operation, the payment server returns payment success information to the resource management server.

In step S104, the resource management server notifies the second management platform of a payment success after the payment server pays successfully, and the second management platform adds resources matching the specified quantity of currencies to an account therein.

After receiving the payment success information returned by the payment server, the resource management server notifies the second management platform of the payment success.

After receiving the payment success information, the second management platform adds the in-account resources matching the specified quantity of currencies for the user terminal.

In the solution according to the embodiment above, the resource management server obtains the resource reallocation instruction from the user terminal, deducts the specified quantity of resources from the first management platform according to the resource reallocation instruction based on the account of the user terminal, sends the payment instruction to the payment server; the payment server pays the specified quantity of currencies from the payment account corresponding to the first management platform to the payment account corresponding to the second management platform, where the specified quantity of currencies matches the specified quantity of resources; the resource management server notifies the second management platform of the payment success after the payment server pays successfully; the second management platform adds the resources matching the specified quantity of currencies to the account therein. In this way, operations of the user for reallocating resources in an account are simplified, the reallocation process is performed in a real-time manner, and a waiting time of the user in switching between accounts is reduced.

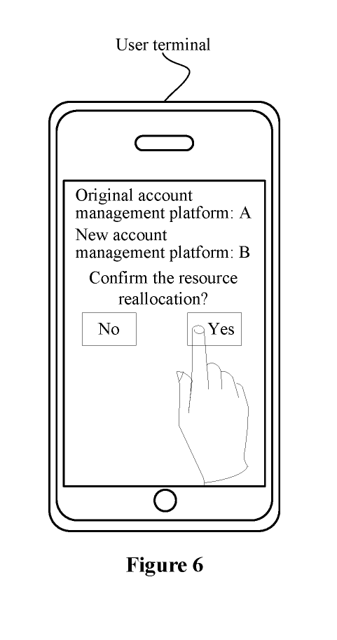

As shown in FIG. 7, a method for reallocating in-account resources among multiple management platforms is provided according to an embodiment of the invention based on the embodiment as shown in FIG. 5. After step S101, in which the resource management server obtains the resource reallocation instruction from the user terminal, the method further includes step S105.

In step S105, the resource management server sends a request instruction of opening a new account to the second management platform, for the second management platform to open a new account corresponding to the user terminal according to the request instruction of opening a new account.

The embodiment differs from the embodiment as shown in FIG. 5 in that the embodiment further includes a solution of opening a new account for the user terminal in the second management platform.

If the user terminal does not have an account in the second management platform and the user needs to allocate resources in the first management platform to the second management platform, only after opening an account in the second management platform can the user allocate the resources in the first management platform to the second management platform, which is taken into consideration in the embodiment.

To be specific, after receiving the resource allocation instruction from the user terminal, the resource management server issues an account opening request to the second management platform. The second management platform opens a new account for the user in response to the account opening request as received, and thereafter returns information that opening of the new account is completed to the resource management server.

Taking a fund account management platform for example, a specific account opening process thereof is described as follows.

First, the resource management server issues a new account opening request to the new account management platform (the second management platform) according to the resource reallocation instruction. The new account management platform completes account opening in response to the new account opening request received, and returns information that opening of the new account is completed to the resource management server.

Thereafter, the resource management server issues a pre-subscribing request to the new account management platform, and the new account management platform generates a new account subscription order in response to the pre-subscribing request received, returns the same to the resource management server and waits for deduction.

In the solution above, the resource management server opens the new account for the user terminal in the second management platform after receiving the resource reallocation instruction from the user terminal. Thereafter, the resource management server deducts the specified quantity of resources form the first management platform according to the resource reallocation instruction, and sends the payment instruction to the payment server. The payment server pays the specified quantity of currencies from the payment account corresponding to the first management platform to the payment account corresponding to the second management platform, where the specified quantity of currencies matches the specified quantity of resources. After the payment server pays successfully, the resource management server notifies the second management platform of the payment success, and the second management platform adds the resources matching the specified quantity of currencies to the new account of the user. In this way, operations of the user for reallocating resources in an account are simplified, the reallocation process is performed in a real-time manner, and a waiting time of the user in switching between accounts is reduced.

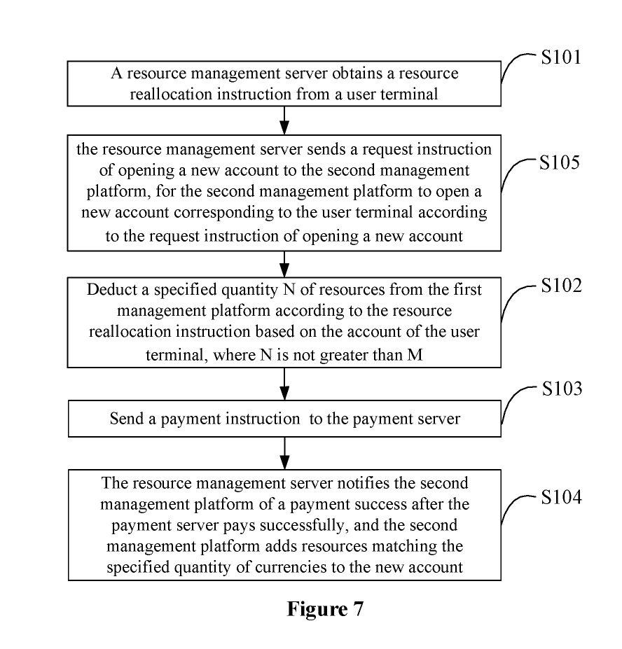

As shown in FIG. 8, a method for reallocating in-account resources among multiple management platforms is provided according to an embodiment of the invention based on the embodiment as shown in FIG. 7. After the second management platform opens the new account, the method further includes step S106.

In step S106, the resource management server locks the new account as opened.

And after step S103, the method further includes step S107.

In step S107, the resource management server unlocks the new account.

The embodiment differs from the embodiment as shown in FIG. 7 in that management and control operations are performed on the new account in the embodiment.

To be specific, after completing opening of the new account in the second management platform, the resource management server locks the new account opened in the second management platform, to facilitate reallocation operations on the resources in the account.

Thereafter, after resources in the first management platform are allocated to the second management platform, the resource management server unlocks the new account locked before.

Through the solution according to the embodiment above, flexible control and management of accounts and a flexible choice between different account management platforms are achieved for the user, operations of the user for reallocating resources in an account are simplified, the resource reallocation process is performed in a real-time manner, and a waiting time of the user in switching between accounts is reduced.

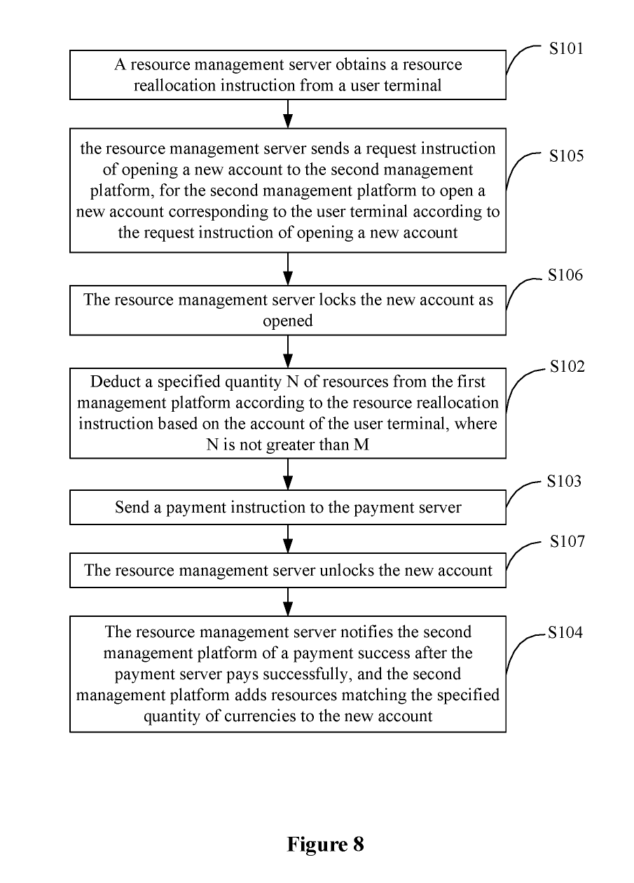

As shown in FIG. 9, a method for reallocating in-account resources among multiple management platforms is provided according to an embodiment of the invention based on the embodiment as shown in FIG. 8. After step S104, the method further includes step S108.

In step S108, the resource management server returns a resource reallocation result to the user terminal.

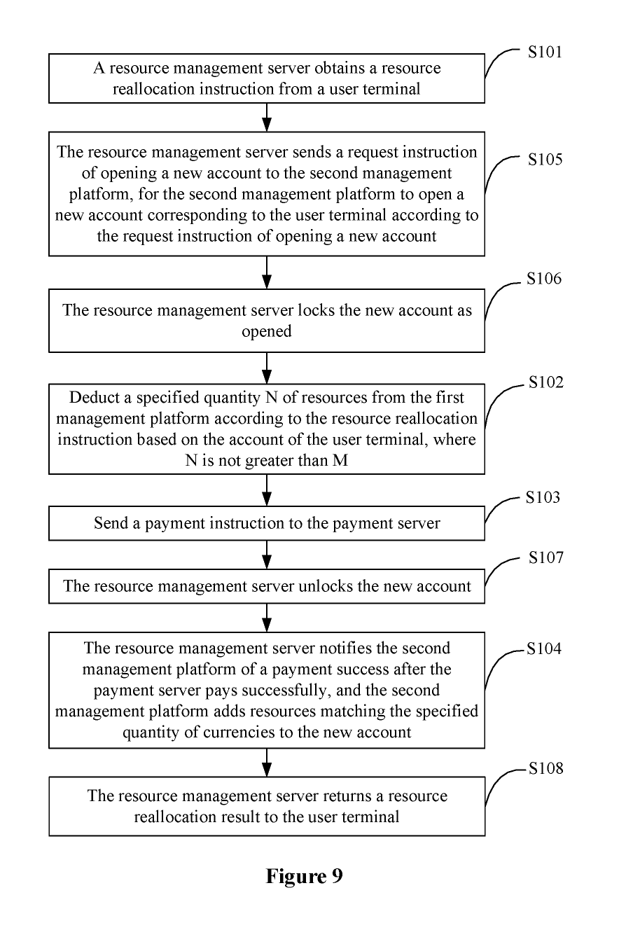

In the embodiment based on the embodiment as shown in FIG. 8, after allocating resources in the account from the first management platform to the second management platform for the user terminal, the resource management server returns the resource reallocation result to the user terminal, for the user to know of a status of the resource allocation. An interface on the user terminal, in which the resource reallocation result is received, may be as shown in FIG. 10.

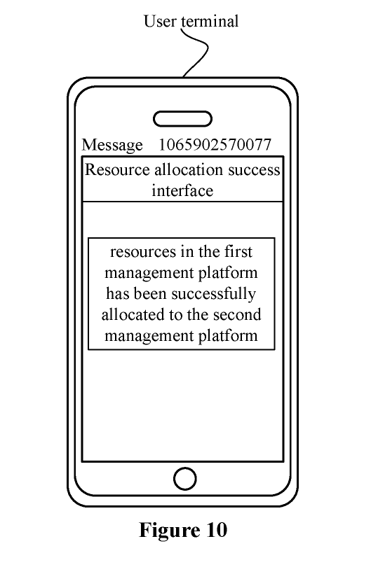

The process of the solution according to the embodiment is described in detail in conjunction with FIG. 11 and taking transferring of shares in an account for example, where FIG. 11 is a schematic diagram of a specific process of transferring the shares in the account according to the embodiment of the invention.

As shown in FIG. 11, with the first management platform defined as an original account management platform A and the second management platform defined as a new account management platform B, the specific process of transferring the shares in the account according to the embodiment is described as follows, which includes steps S10 to S22.

In step S10, the user terminal sends a resource reallocation instruction to the resource management server.

If the user selects the new account management platform B and wants to transfer shares in the original account management platform A to the new account management platform B, the user terminal sends the resource reallocation instruction to the resource management server, to request transferring of the shares in the account.

In step S11, a new account is opened.

The resource management server sends an account opening request to the new account management platform B, and the new account management platform B opens the new account in response to the account opening request.

In step S12, the new account management platform returns account opening success information after opening the new account.

In step S13, the resource management server issues a pre-subscribing request to the new account management platform B.

In step S14, the new account management platform B returns a subscription order and waits for deduction.

In step S15, the resource management server locks the new account of the user.

In step S16, the resource management server redeems the shares in an original account from the original account management platform A.

In step S17, the original account management platform A returns redemption and deduction success information.

In step S18, the resource management server notifies the payment server to transfer the shares as redeemed of the original account to the new account.

In step S19, the payment server returns transfer success information to the resource management server.

In step S20, the resource management server notifies the new account management platform B of a payment success.

In step S21, the resource management server unlocks the new account.

In step S22, the resource management server returns share transfer success information to the user terminal.

Taking fund products of fund companies for example, the user owns fund shares of a fund company A, and if the user finds a fund product with more profits from another fund company B, the user can choose to transfer all already-owned shares to a product of a new fund company. All the user needs to do is to select the fund product to be transferred to and submit a share transfer request.

The resource management server opens an account in the fund company B to be transferred to and issues a pre-subscribing request at background for the user, redeems all the fund shares owned by the user in the fund company A, transfers all money to an account of the company B and notifies the fund company B of a deduction completion. And then the fund company B adds shares for the user.

The whole operating process is performed synchronously, and the user can obtain a transfer result in a real-time manner without waiting until the money is credited into account and see own shares held in the fund product of the fund company B, which greatly reduces a waiting time of the user, improves user experience and increases profits of the user

Transferring of shares in accounts between different fund products of a same fund company may also be implemented through the solution according to the embodiment, which is not described herein redundantly.

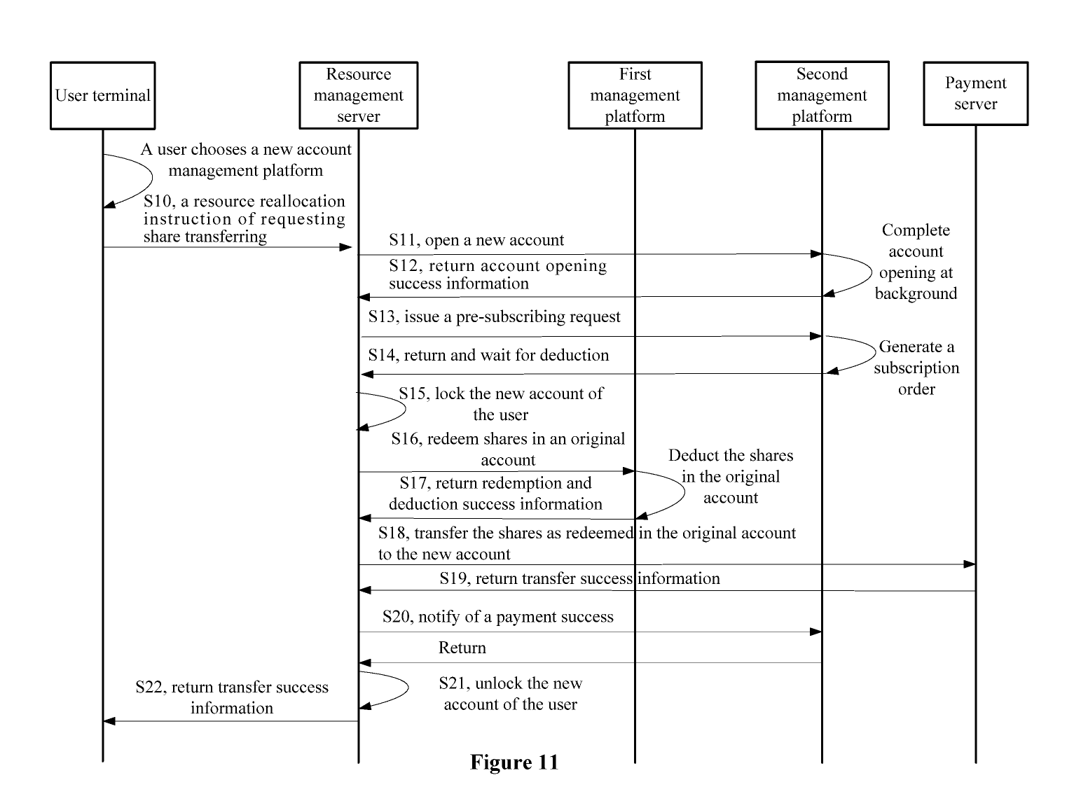

As shown in FIG. 12, a method for reallocating in-account resources among multiple management platforms is provided according to an embodiment of the invention, which includes steps S201 to S207.

In step S201, a user terminal sends a resource reallocation instruction to a resource management server, where the resource reallocation instruction includes information of reallocation of resources in an account registered by the user terminal in the resource management server among multiple platforms, where the multiple platforms include at least a first management platform and a second management platform and a predetermined quantity M of the resources in the account is allocated to the first management platform;

In step S202, the resource management server receives the resource reallocation instruction from the user terminal, and sends an account resource deduction instruction to the first management platform according to the resource reallocation instruction based on the account of the user terminal.

An implementation environment of the method according to the embodiment of the invention involves a user terminal, a resource management server, a payment server and multiple management platforms, where the first management platform and the second management platform are taken for example in the embodiment.

The user terminal may include, but not limited to, Personal Computer (PC) or mobile device such as smart phone (such as Android phone or iOS phone), tablet computer, palm computer, mobile internet device (MID) or PAD. The user terminal is installed with account operating application software (for example, fund software).

The resource management server is a server for managing allocation of resources in user among different management platforms.

The payment server, as a background server of the resource management server, implements specific payment services in the allocation of resources in the user account.

The multiple management platforms are each configured to manage for themselves operations such as opening accounts, subscribing shares for accounts, transacting between accounts and redeeming shares in accounts. For example, in a case of fund products, the multiple management platforms may be fund product management platforms corresponding to different fund companies, or different account management platforms in a same fund company.

Existing account management platforms generally do not support transferring of shares subscribed by a user between accounts. Taking fund products of fund companies for example, if the user wants to switch between funds, the user has to entirely redeem a fund and purchase other funds (including other funds of a current fund company and funds of other fund companies) after money in the fund is credited into account. The user has to perform the subscribing and redeeming processes, which results in a complex operating process for reallocating resources of the user, and in addition, a waiting time of the user is increased for the user can not subscribe a new fund product until the money of the original fund is credited into account.

In the embodiment, a flexible choice among different management platforms can be achieved for the user, and the resource reallocation process can be simplified. In addition, the resource reallocation process is performed in a real-time manner and a waiting time of the user in switching between accounts is reduced

To be specific, once the user chooses to transfer resources in one management platform to another, for example, reallocate resources in the first management platform to the second management platform, the user sends the resource reallocation instruction to the resource management server through the user terminal.

The resource reallocation instruction includes information of reallocation of the resources, in the account registered by the user terminal in the resource management server, between the first management platform and the second management platform, i.e., includes account information of the user in the first management platform, and the specified quantity M of the resources, which the user allocates to the first management platform. Besides, it is presumed in the embodiment that the user has a new account in the second management platform.

Taking fund account management platforms for example, once the user chooses a new fund company and needs to transfer shares in an account in an original account management platform to a new account management platform, the user terminal sends a resource reallocation instruction to the resource management server, where the resource reallocation instruction carries information such as names of the original account management platform and the new account management platform, the subscribing account of the user in the original account management platform and the shares in the account.

The resource management server may provide an operating interface for the user to choose, as is shown in FIG. 6. When selecting the new account management platform and requesting a resource reallocation, the user is prompted for a confirmation, and if the user taps a confirm button, subsequent resource reallocating and transferring operations are performed.

In step S203, a specified quantity N of resources is deducted from the first management platform according to the account resource deduction instruction, where N is not greater than M.

After receiving the resource reallocation instruction from the user terminal, the resource management server deducts the specified quantity N of resources from the first management platform based on the account of the user terminal in the resource management server, where N is not greater than M (the quantity of resources the user allocates to the first management platform). To facilitate the deducting operation of the resource management server, the resource management server may in advance bond an account registered by the user in the resource management server and a subscribing account of the user in the first management platform.

Taking fund account management platforms for example, after receiving the resource allocation instruction from the user terminal, the resource management server needs to complete switching between transaction accounts of the user and redeems shares in an original account from the original account management platform (the first management platform), where the shares in the original account is obtained from the resource allocation instruction from the user terminal.

The resource management server sends a redemption request for the shares in the original account to the original account management platform, and the original account management platform deducts the shares in the original account of the user in response to the redemption request from the resource management server.

In step S204, the resource management server sends a payment instruction to the payment server, where the payment instruction includes paying a specified quantity of currencies from a payment account corresponding to the first management platform to a payment account corresponding to the second management platform, where the specified quantity of currencies matches the specified quantity N of resources.

In step S205, the payment server pays the specified quantity of currencies from the payment account corresponding to the first management platform to the payment account corresponding to the second management platform according to the payment instruction, where the specified quantity of currencies matches the specified quantity N of resources.

After deducting the specified quantity N of resources from the first management platform according to the resource reallocation instruction from the user terminal, the resource management server notifies the payment server to perform a payment operation. The payment server pays the specified quantity of currencies from the payment account corresponding to the first management platform to the payment account corresponding to the second management platform according to a payment instruction of the resource management server, where the specified quantity of currencies matches the specified quantity N of resources deducted by the resource management server.

After completing the payment operation, the payment server returns payment success information to the resource management server.

In step S206, the resource management server notifies the second management platform of a payment success after the payment server pays successfully.

In step S207, the second management platform adds resources matching the specified quantity of currencies to an account therein.

After receiving the payment success information returned by the payment server, the resource management server notifies the second management platform of the payment success.

After receiving the payment success information, the second management platform adds the resources matching the specified quantity of currencies to the account therein for the user terminal.

In the solution according to the embodiment above, the resource management server obtains the resource reallocation instruction from the user terminal, deducts the specified quantity of resources from the first management platform according to the resource reallocation instruction based on the account of the user terminal, sends the payment instruction to the payment server for the payment server to pay the specified quantity of currencies from the payment account corresponding to the first management platform to the payment account corresponding to the second management platform, where the specified quantity of currencies matches the specified quantity of resources, notifies the second management platform of the payment success after the payment server pays successfully, for the second management platform to add the resources matching the specified quantity of currencies to the account therein. In this way, operations of the user for reallocating resources in an account are simplified, the reallocation process is performed in a real-time manner, and a waiting time of the user in switching between accounts is reduced.

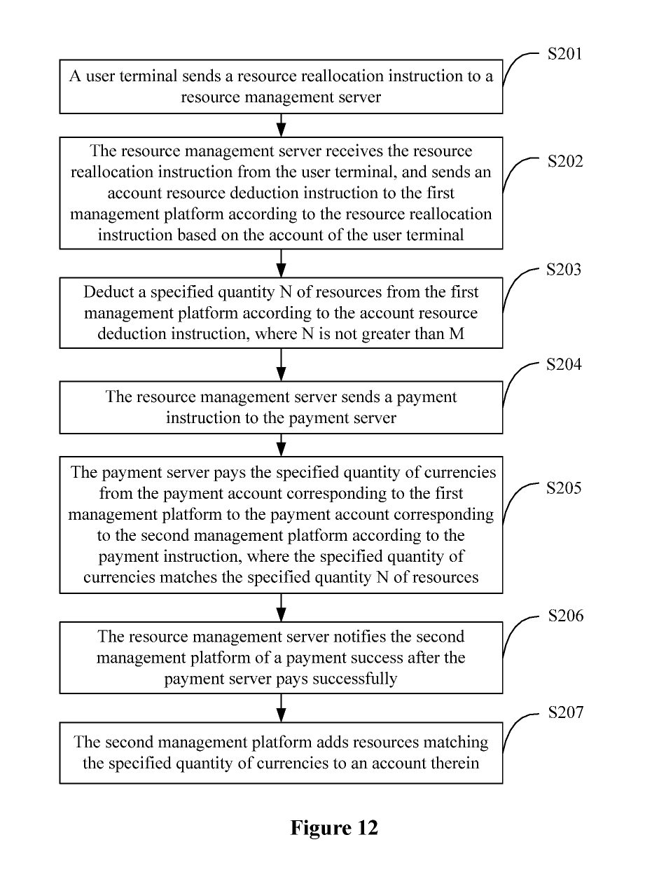

As shown in FIG. 13, a method for reallocating in-account resources among multiple management platforms is provided according to an embodiment of the invention based on the embodiment as shown in FIG. 12. After the resource management server receives the resource reallocation instruction from the user terminal, the method further includes steps S208 and S209.

In step S208, the resource management server sends a request instruction of opening a new account to the second management platform.

In step S209, the second management platform opens a new account corresponding to the user terminal according to the request instruction of opening a new account.

The embodiment differs from the embodiment as shown in FIG. 12 in that the embodiment further includes a solution of opening a new account for the user terminal in the second management platform.

If the user terminal does not have an account in the second management platform and the user needs to allocate resources in the first management platform to the second management platform, only after opening an account in the second management platform can the user allocate the resources in the first management platform to the second management platform, which is taken into consideration in the embodiment.

To be specific, after receiving the resource allocation instruction from the user terminal, the resource management server issues an account opening request to the second management platform. The second management platform opens a new account for the user in response to the account opening request as received, and thereafter returns information that opening of the new account is completed to the resource management server.

Taking a fund account management platform for example, a specific account opening process thereof is described as follows.

First, the resource management server issues a new account opening request to the new account management platform (the second management platform) according to the resource reallocation instruction. The new account management platform completes account opening in response to the new account opening request received, and returns information that opening of a new account is completed to the resource management server.

Thereafter, the resource management server issues a pre-subscribing request to the new account management platform, and the new account management platform generates a new account subscription order in response to the pre-subscribing request received, returns the same to the resource management server and waits for deduction.

In the solution above, the resource management server opens the new account for the user terminal in the second management platform after receiving the resource reallocation instruction from the user terminal. Thereafter, the resource management server deducts the specified quantity of resources from the first management platform according to the resource reallocation instruction, and sends the payment instruction to the payment server. The payment server pays the specified quantity of currencies from the payment account corresponding to the first management platform to the payment account corresponding to the second management platform, where the specified quantity of currencies matches the specified quantity of resources. After the payment server pays successfully, the resource management server notifies the second management platform of the payment success, and the second management platform adds the resources matching the specified quantity of currencies to the new account of the user. In this way, operations of the user for reallocating resources in an account are simplified, the reallocation process is performed in a real-time manner, and a waiting time of the user in switching between accounts is reduced.

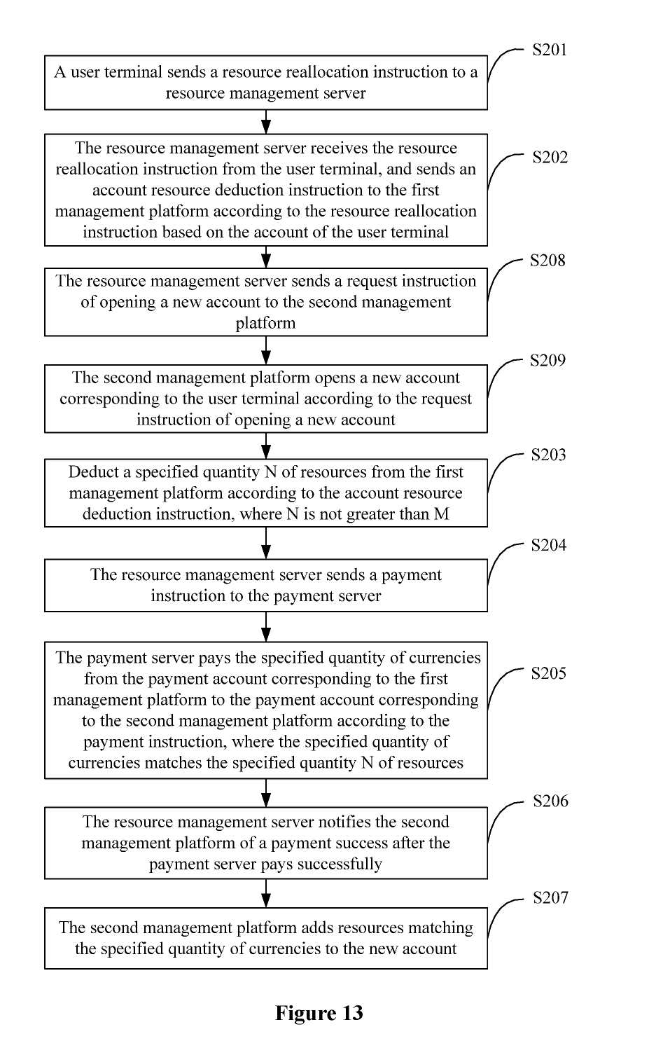

As shown in FIG. 14, a method for reallocating in-account resources among multiple management platforms is provided according to an embodiment of the invention based on the embodiment as shown in FIG. 13. After the second management platform opens the new account, the method further includes step S210.

In step S210, the resource management server locks the new account as opened.

And the after the payment server pays successfully, the method further includes step S211.

In step S211, the resource management server unlocks the new account.

The embodiment differs from the embodiment as shown in FIG. 13 in that management and control operations are performed on the new account in the embodiment.

To be specific, after completing opening of the new account in the second management platform, the resource management server locks the new account as opened in the second management platform, to facilitate reallocation operations on the resources in the account.

Thereafter, after resources in the first management platform are allocated to the second management platform, the resource management server unlocks the new account as locked.

Through the solution according to the embodiment above, flexible control and management of accounts and a flexible choice between different account management platforms are achieved for the user, operations of the user for reallocating resources in an account are simplified, the resource reallocation process is performed in a real-time manner, and a waiting time of the user in switching between accounts is reduced.

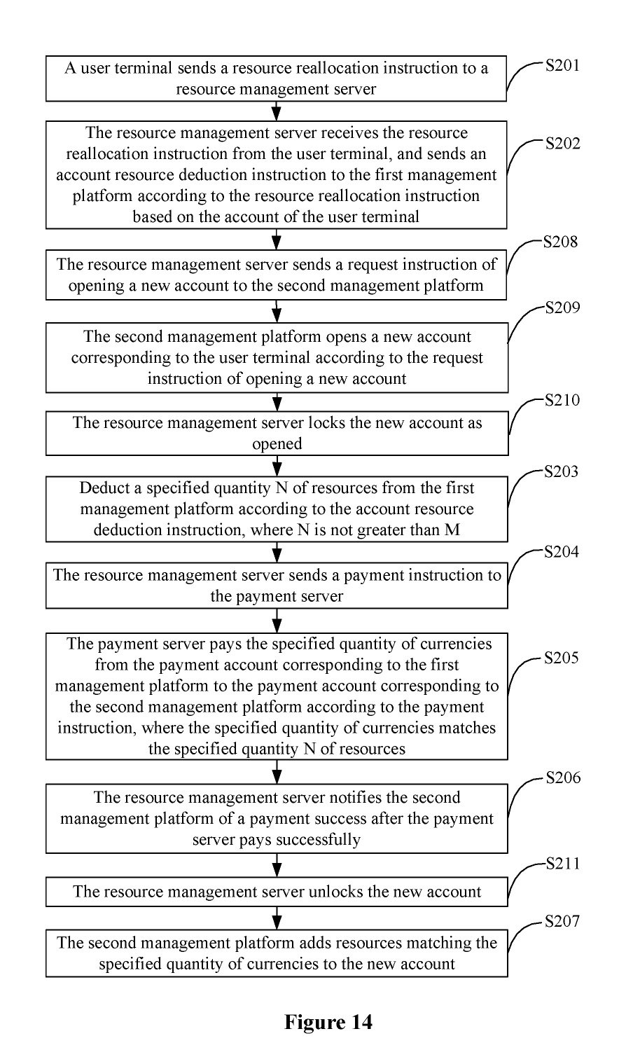

As shown in FIG. 15, a method for reallocating in-account resources among multiple management platforms is provided according to an embodiment of the invention based on the embodiment as shown in FIG. 14. After step S207, the method further includes step S212.

In step S212, the resource management server returns a resource reallocation result to the user terminal.

In the embodiment based on the embodiment as shown in FIG. 14, after allocating resources in the account from the first management platform to the second management platform for the user terminal, the resource management server returns the resource reallocation result to the user terminal, for the user to know of a status of the resource allocation. An interface on the user terminal, in which the resource reallocation result is received, may be as shown in FIG. 10.

The process of the solution according to the embodiment is described in detail in conjunction with FIG. 11 and taking transferring of shares in an account for example, where FIG. 11 is a schematic diagram of a specific process of transferring the shares in the account according to the embodiment of the invention.

As shown in FIG. 11, with the first management platform defined as an original account management platform A and the second management platform defined as a new account management platform B, the specific process of transferring the shares in the account according to the embodiment is described as follows, which includes steps S10 to S22.

In step S10, the user terminal sends a resource reallocation instruction to the resource management server.

If the user selects the new account management platform B and wants to transfer shares in the original account management platform A to the new account management platform B, the user terminal sends the resource reallocation instruction to the resource management server, to request transferring of the shares in the account

In step S11, a new account is opened.

The resource management server sends an account opening request to the new account management platform B, and the new account management platform B opens the new account in response to the account opening request.

In step S12, the new account management platform returns account opening success information after opening the new account.

In step S13, the resource management server issues a pre-subscribing request to the new account management platform B.

In step S14, the new account management platform B returns a subscription order and waits for deduction.

In step S15, the resource management server locks the new account of the user.

In step S16, the resource management server redeems the shares in an original account from the original account management platform A.

In step S17, the original account management platform A returns redemption and deduction success information.

In step S18, the resource management server notifies the payment server to transfer the shares as redeemed of the original account to the new account.

In step S19, the payment server returns transfer success information to the resource management server.

In step S20, the resource management server notifies the new account management platform B of a payment success.

In step S21, the resource management server unlocks the new account.

In step S22, the resource management server returns share transfer success information to the user terminal.

Taking fund products of fund companies for example, the user owns fund shares of a fund company A, and if the user finds a fund product with more profits from another fund company B, the user can choose to transfer all already-owned shares to a product of a new fund company. All the user needs to do is to select the fund product to be transferred to and submit a share transfer request.

The resource management server opens an account in the fund company B to be transferred to and issues a pre-subscribing request at background, redeems all the fund shares owned by the user in the fund company A, transfers all money to an account of the company B and notifies the fund company B of a deduction completion. And then the fund company B adds shares for the user.

The whole operating process is performed synchronously, and the user can obtain a transfer result in a real-time manner without waiting until the money is credited into account and see own shares held in the fund product of the fund company B, which greatly reduces a waiting time of the user, improves user experience and increases profits of the user

Transferring of shares in accounts between different fund products of a same fund company may also be implemented through the solution according to the embodiment, which is not described herein redundantly.

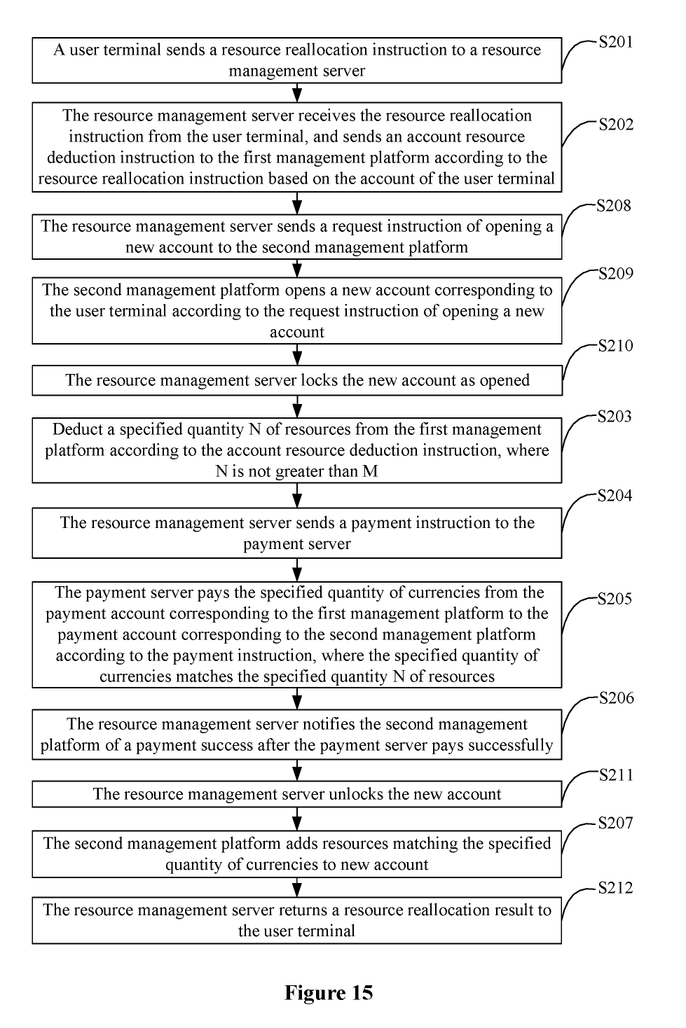

As shown in FIG. 16, a resource management server for reallocating in-account resources among multiple management platforms is provided according to an embodiment of the invention, which includes an obtaining module 301, a deducting module 302, a requesting module 303 and a notifying module 304.

The obtaining module 301 is configured to obtain a resource reallocation instruction from a user terminal, where the resource reallocation instruction includes information of reallocation of resources in an account registered by the user terminal in a resource management server among multiple platforms, where the multiple platforms include at least a first management platform and a second management platform and a predetermined quantity M of the resources in the account is allocated to the first management platform;

the deducting module 302 is configured to deduct a specified quantity N of resources from the first management platform according to the resource reallocation instruction based on the account of the user terminal, where N is not greater than M;

the requesting module 303 is configured to send a payment instruction to a payment server, where the payment instruction includes paying a specified quantity of currencies from a payment account corresponding to the first management platform to a payment account corresponding to the second management platform, where the specified quantity of currencies matches the specified quantity N of resources; and

the notifying module 304 is configured to notify the second management platform of a payment success after the payment server pays successfully, for the second management platform to add resources matching the specified quantity of currencies to an account therein.

The solution according to the embodiment involves a user terminal, a resource management server, a payment server and multiple management platforms, where the first management platform and the second management platform are taken for example in the embodiment.

The user terminal may include, but not limited to, Personal Computer (PC) or mobile device such as smart phone (such as Android phone or iOS phone), tablet computer, palm computer, mobile internet device (MID) or PAD. The user terminal is installed with account operating application software (for example, fund software).

The resource management server is a server for managing allocation of resources in user account among different management platforms.

The payment server, as a background server of the resource management server, implements specific payment services in the allocation of resources in the user account.

The multiple management platforms are each configured to manage for themselves operations such as opening accounts, subscribing shares for accounts, transacting between accounts and redeeming shares in accounts. For example, in a case of fund products, the multiple management platforms may be fund product management platforms corresponding to different fund companies, or different account management platforms in a same fund company.

Existing account management platforms generally do not support transferring of shares subscribed by a user between accounts. Taking fund products of fund companies for example, if the user wants to switch between funds, the user has to entirely redeem a fund and purchase other funds (including other funds of a current fund company and funds of other fund companies) after money in the fund is credited into account. The user has to perform the subscribing and redeeming processes, which results in a complex operating process for reallocating resources of the user, and in addition, a waiting time of the user is increased for the user can not subscribe a new fund product until the money of the original fund is credited into account.

In the embodiment, a flexible choice between different management platforms can be achieved for the user, and the resource reallocation process can be simplified. In addition, the resource reallocation process is performed in a real-time manner and a waiting time of the user in switching between accounts is reduced

To be specific, once the user chooses to transfer resources in one management platform to another, for example, reallocate resources in the first management platform to the second management platform, the user sends the resource reallocation instruction to the resource management server through the user terminal.

The resource reallocation instruction includes information of reallocation of the resources in the account registered by the user terminal in the resource management server between the first management platform and the second management platform, i.e., includes account information of the user in the first management platform, and the specified quantity M of the resources, which the user allocates to the first management platform. Besides, it is presumed in the embodiment that the user has a new account in the second management platform.

Taking fund account management platforms for example, if the user chooses a new fund company and needs to transfer shares in an account in an original account management platform to a new account management platform, the user terminal sends a resource reallocation instruction to the resource management server, where the resource reallocation instruction carries information such as names of the original account management platform and the new account management platform, the subscribing account of the user in the original account management platform and the shares in the account.

The resource management server may provide an operating interface for the user to choose, as is shown in FIG. 6. When selecting the new account management platform and requesting a resource reallocation, the user is prompted for a confirmation, and if the user taps a confirm button, subsequent resource reallocating and transferring operations are performed.

After receiving the resource reallocation instruction from the user terminal, the resource management server deducts the specified quantity N of resources from the first management platform based on the account of the user terminal in the resource management server, where N is not greater than M (the quantity of resources the user allocates to the first management platform). To facilitate the deducting operation of the resource management server, the resource management server may in advance bond an account registered by the user in the resource management server and a subscribing account of the user in the first management platform.

Taking fund account management platforms for example, after receiving the resource allocation instruction from the user terminal, the resource management server needs to complete switching between transaction accounts of the user and redeems shares in an original account from the original account management platform (the first management platform), where the shares in the original account is obtained from the resource allocation instruction from the user terminal.

The resource management server sends a redemption request for the shares in the original account to the original account management platform, and the original account management platform deducts the shares in the original account of the user in response to the redemption request from the resource management server.

After deducting the specified quantity N of resources from the first management platform according to the resource reallocation instruction from the user terminal, the resource management server notifies the payment server to perform a payment operation. The payment server pays the specified quantity of currencies from the payment account corresponding to the first management platform to the payment account corresponding to the second management platform according to a payment instruction of the resource management server, where the specified quantity of currencies matches the specified quantity N of resources deducted by the resource management server.

After completing the payment operation, the payment server returns payment success information to the resource management server.

After receiving the payment success information returned by the payment server, the payment server notifies the second management platform of the payment success.

After receiving the payment success information, the second management platform adds the resources matching the specified quantity of currencies to the account therein for the user terminal.

In the solution according to the embodiment above, the resource management server obtains the resource reallocation instruction from the user terminal, deducts the specified quantity of resources from the first management platform according to the resource reallocation instruction based on the account of the user terminal, sends the payment instruction to the payment server for the payment server to pay the specified quantity of currencies from the payment account corresponding to the first management platform to the payment account corresponding to the second management platform, where the specified quantity of currencies matches the specified quantity of resources, notifies the second management platform of the payment success after the payment server pays successfully, for the second management platform to add the resources matching the specified quantity of currencies to the account therein. In this way, operations of the user for reallocating resources in an account are simplified, the reallocation process is performed in a real-time manner, and a waiting time of the user in switching between accounts is reduced.

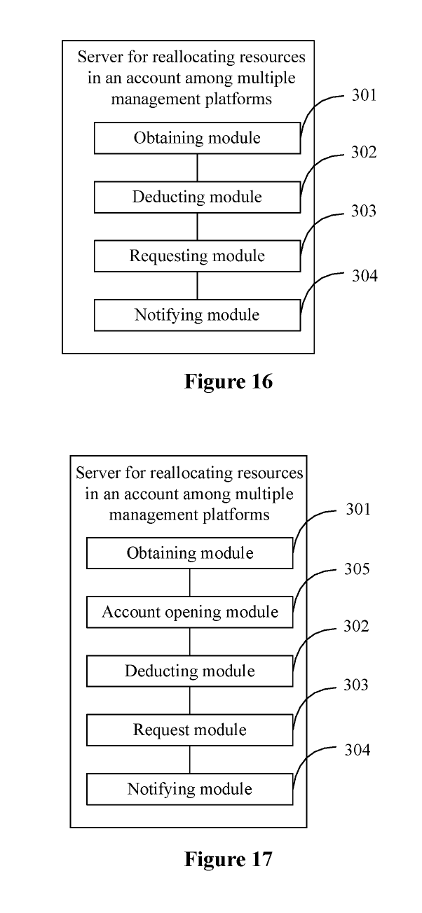

As shown in FIG. 17, a resource management server for reallocating in-account resources among multiple management platforms is provided according to an embodiment of the invention based on the embodiment as shown in FIG. 16, which further includes:

an account opening module 305, configured to send a request instruction of opening a new account to the second management platform, for the second management platform to open a new account corresponding to the user terminal according to the request instruction of opening a new account.

The embodiment differs from the embodiment as shown in FIG. 16 in that the embodiment further includes a solution of opening a new account for the user terminal in the second management platform.

If the user terminal does not have an account in the second management platform and the user needs to allocate resources in the first management platform to the second management platform, only after opening an account in the second management platform can the user allocate the resources in the first management platform to the second management platform, which is taken into consideration in the embodiment.

To be specific, after receiving the resource allocation instruction from the user terminal, the resource management server issues an account opening request to the second management platform. The second management platform opens a new account for the user in response to the account opening request as received, and thereafter returns information that opening of the new account is completed to the resource management server.

Taking a fund account management platform for example, a specific account opening process thereof is described as follows.

First, the resource management server issues a new account opening request to the new account management platform (the second management platform) according to the resource reallocation instruction. The new account management platform completes account opening in response to the new account opening request received, and returns information that opening of a new account is completed to the resource management server.

Thereafter, the resource management server issues a pre-subscribing request to the new account management platform, and the new account management platform generates a new account subscription order in response to the pre-subscribing request received, returns the same to the resource management server and waits for deduction.

In the solution above, the resource management server opens the new account for the user terminal in the second management platform after receiving the resource reallocation instruction from the user terminal. Thereafter, the resource management server deducts the specified quantity of resources from the first management platform according to the resource reallocation instruction, and sends the payment instruction to the payment server. The payment server pays the specified quantity of currencies from the payment account corresponding to the first management platform to the payment account corresponding to the second management platform, where the specified quantity of currencies matches the specified quantity of resources. After the payment server pays successfully, the resource management server notifies the second management platform of the payment success, and the second management platform adds the resources matching the specified quantity of currencies to the new account of the user. In this way, operations of the user for reallocating resources in an account are simplified, the reallocation process is performed in a real-time manner, and a waiting time of the user in switching between accounts is reduced.

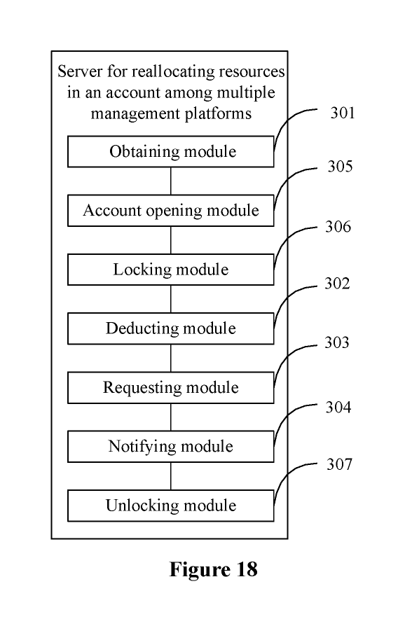

As shown in FIG. 18, a resource management server for reallocating in-account resources among multiple management platforms is provided according to an embodiment of the invention based on the embodiment as shown in FIG. 17, which further includes:

a locking module 306, configured to lock the new account as opened after the second management platform opens the new account; and

an unlocking module 307, configured to unlock the new account after the payment server pays successfully.

The embodiment differs from the embodiment as shown in FIG. 17 in that management and control operations are performed on the new account in the embodiment.

To be specific, after completing opening of the new account in the second management platform, the resource management server locks the new account as opened in the second management platform, to facilitate reallocation operations on the resources in the account.

Thereafter, after resources in the first management platform are allocated to the second management platform, the resource management server unlocks the new account as locked.

Through the solution according to the embodiment above, flexible control and management of accounts and a flexible choice between different account management platforms are achieved for the user, operations of the user for reallocating resources in an account are simplified, the resource reallocation process is performed in a real-time manner, and a waiting time of the user in switching between accounts is reduced.

Further, the notifying module 304 is further configured to return a resource reallocation result to the user terminal. After allocating resources in the account from the first management platform to the second management platform for the user terminal, the resource management server returns the resource reallocation result to the user terminal, for the user to know of a status of the resource allocation. An interface on the user terminal, in which the resource reallocation result is received, may be as shown in FIG. 10.

The process of the solution according to the embodiment is described in detail in conjunction with FIG. 11 and taking transferring of shares in an account for example, where FIG. 11 is a schematic diagram of a specific process of transferring the shares in the account according to the embodiment of the invention.

As shown in FIG. 11, with the first management platform defined as an original account management platform A and the second management platform defined as a new account management platform B, the specific process of transferring the shares in the account according to the embodiment is described as follows, which includes steps S10 to S22.

In step S10, the user terminal sends a resource reallocation instruction to the resource management server.

Once the user selects the new account management platform B and wants to transfer shares in the original account management platform A to the new account management platform B, the user terminal sends the resource reallocation instruction to the resource management server, to request transferring of the shares in the account

In step S11, a new account is opened.

The resource management server sends an account opening request to the new account management platform B, and the new account management platform B opens the new account in response to the account opening request.

In step S12, the new account management platform returns account opening success information after opening the new account.

In step S13, the resource management server issues a pre-subscribing request to the new account management platform B.

In step S14, the new account management platform B returns a subscription order and waits for deduction.

In step S15, the resource management server locks the new account of the user.

In step S16, the resource management server redeems the shares in an original account from the original account management platform A.

In step S17, the original account management platform A returns redemption and deduction success information.

In step S18, the resource management server notifies the payment server to transfer the shares as redeemed of the original account to the new account.

In step S19, the payment server returns transfer success information to the resource management server.

In step S20, the resource management server notifies the new account management platform B of a payment success.

In step S21, the resource management server unlocks the new account.

In step S22, the resource management server returns share transfer success information to the user terminal.

Taking fund products of fund companies for example, the user owns fund shares of a fund company A, and if the user finds a fund product with more profits of another fund company B, the user can choose to transfer all already-owned shares to a product of a new fund company. All the user needs to do is to select the fund product to be transferred to and submit a share transfer request.

The resource management server opens an account in the fund company B to be transferred to and issues a pre-subscribing request at background, redeems all the fund shares owned by the user in the fund company A, transfers all money to an account of the company B and notifies the fund company B of a deduction completion. And then the fund company B adds shares for the user.

The whole operating process is performed synchronously, and the user can obtain a transfer result in a real-time manner without waiting until the money is credited into account and see own shares held in the fund product of the fund company B, which greatly reduces a waiting time of the user, improves user experience and increases profits of the user

Transferring of shares in accounts between different fund products of a same fund company may also be implemented through the solution according to the embodiment, which is not described herein redundantly.

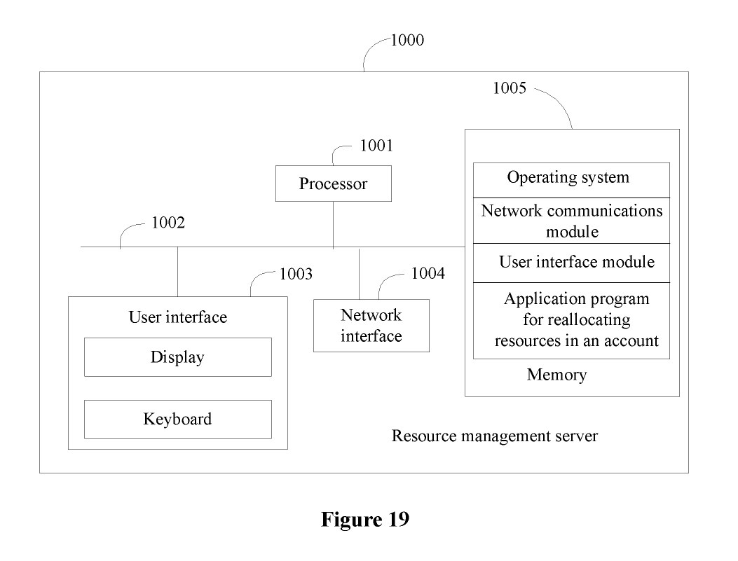

Reference is made to FIG. 19, which shows a structure of a server for reallocating in-account resources among multiple management platforms according to an embodiment of the invention.

As shown in FIG. 19, the value-added server 1000 may include at least one processor 1001, for example, a CPU (central processing unit), at least one network interface 1004, a user interface 1003, a memory 1005 and at least one communications bus 1002. The at least one communications bus 1002 is used to realize connections and communications between the components. The user interface 1003 may include a display and a keyboard, and optionally, the user interface 1003 may further include a standard wired interface and a standard wireless interface. The at least one network interface 1004 may optionally include a standard wired interface and a standard wireless interface (for example, a Wi-Fi interface). The memory 1005 may be a high-speed RAM (random access memory) or a non-volatile memory (non-volatile memory), for example, at least one disk memory. Optionally, the memory 1005 may be at least one storage apparatus away from the at least one processor 1001. As shown in FIG. 19, the memory 1005 functioning as a computer storage medium may include an operating system, a network communications module, a user interface module and an application program for reallocating in-account resources among multiple management platforms.

In the value-added server 1000 as shown in FIG. 19, the at least one network interface 1004 is mainly configured to connect the resource management server to a payment server, a first management platform and a second management platform, and perform data communications with the payment server, the first management platform and the second management platform. The user interface 1003 is mainly configured to connect to a user terminal and perform data communications with the user terminal. The at least one processor 1001 may be configured to call the application program for reallocating in-account resources among multiple management platforms stored in the memory 1005, to perform the following operations:

obtaining a resource reallocation instruction from a user terminal through the user interface 1003;

interacting with the first management platform through the at least one network interface 1004, to deduct a specified quantity N of resources in the first management platform, where N is not greater than M;

sending a payment instruction to the payment server through the at least one network interface 1004, where the payment instruction includes paying a specified quantity of currencies from a payment account corresponding to the first management platform to a payment account corresponding to the second management platform, where the specified quantity of currencies matches the specified quantity N of resources;

notifying the second management platform of a payment success through the at least one network interface 1004 after the payment server pays successfully, for the second management platform to add resources matching the specified quantity of currencies to an account therein, thereby achieving reallocation of the resources in the account between the multiple management platforms.

In an embodiment, the at least one processor 1001 may call the application program for reallocating in-account resources among multiple management platforms stored in the memory 1005, to perform the following operations:

sending a request instruction of opening a new account to the second management platform through the at least one network interface 1004, for the second management platform to open a new account corresponding to the user terminal according to the request instruction of opening a new account;

further, locking the new account as opened after the second management platform opens the new account and unlocking the new account after the payment server pays successfully; and

further, returning a resource reallocation result to the user terminal through the user interface 1003.

In the solution according to the embodiment above, the resource management server obtains the resource reallocation instruction from the user terminal, deducts the specified quantity of resources from the first management platform according to the resource reallocation instruction based on the account of the user terminal, sends the payment instruction to the payment server for the payment server to pay the specified quantity of currencies from the payment account corresponding to the first management platform to the payment account corresponding to the second management platform, where the specified quantity of currencies matches the specified quantity of resources, notifies the second management platform of the payment success after the payment server pays successfully, for the second management platform to add the resources matching the specified quantity of currencies to the account therein. In this way, operations of the user for reallocating resources in an account are simplified, the reallocation process is performed in a real-time manner, and a waiting time of the user in switching between accounts is reduced.

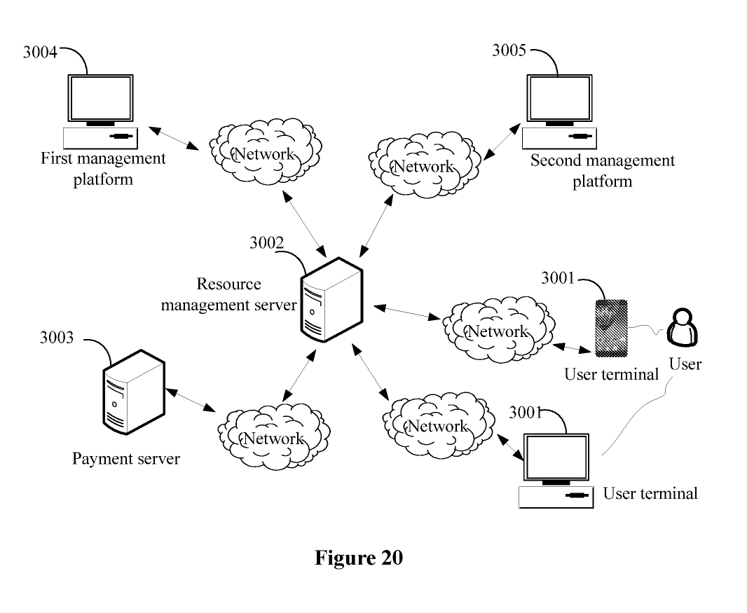

FIG. 20 is a schematic architecture diagram of a system for reallocating in-account resources among multiple management platforms according to a preferred embodiment of the invention. The system includes a user terminal 3001, a resource management server 3002 and a payment server 3003. The resource management server 3002 is in communications connections with the user terminal 3001 and the payment server 3003 through networks, respectively, and is also in communications connections with a first management platform 3004 and a second management platform 3005 through networks, respectively.

The user terminal 3001 may include, but not limited to, Personal Computer (PC) or mobile device such as smart phone (such as Android phone or iOS phone), tablet computer, palm computer, mobile internet device (MID) or PAD. The user terminal 3001 is installed with account operating application software (for example, fund software).

The resource management server 3002 is a server for managing reallocation of resources in an account of a user between different management platforms.

The payment server 3003 is configured to implement specific payment services in reallocation of resources in an account of a user as a background server of the resource management server 3002.

The multiple management platforms are each configured to manage for themselves operations such as opening accounts, subscribing shares for accounts, transacting between accounts and redeeming shares in accounts. For example, in a case of fund products, the multiple management platforms may be fund product management platforms corresponding to different fund companies, or different account management platforms in a same fund company.

Existing account management platforms generally do not support transferring of shares subscribed by a user between accounts. Taking fund products of fund companies for example, if the user wants to switch between funds, the user has to entirely redeem a fund and purchase other funds (including other funds of a current fund company and funds of other fund companies) after money in the fund is credited into account. The user has to perform the subscribing and redeeming processes, which results in a complex operating process for reallocating resources of the user, and in addition, a waiting time of the user is increased for the user can not subscribe a new fund product until the money of the original fund is credited into account.

In the embodiment, a flexible choice between different management platforms can be achieved for the user, and the resource reallocation process can be simplified. In addition, the resource reallocation process is performed in a real-time manner and a waiting time of the user in switching between accounts is reduced

To be specific, once the user chooses to transfer resources in one management platform to another, for example, reallocate resources in the first management platform 3004 to the second management platform 3005, the user sends a resource reallocation instruction to the resource management server 3002 through the user terminal 3001.

The resource reallocation instruction includes information of reallocation of resources in an account registered by the user terminal 3001 in the resource management server 3002 between the first management platform 3004 and the second management platform 3005, i.e., includes account information of the user in the first management platform 3004, and a specified quantity M of the resources, which the user allocates to the first management platform 3004. Besides, it is presumed that the user has a new account in the second management platform 3005 in the embodiment.

Taking fund account management platforms for example, once the user chooses a new fund company and needs to transfer shares in an account in an original account management platform to a new account management platform, the user terminal 3001 sends a resource reallocation instruction to the resource management server 3002, where the resource reallocation instruction carries information such as names of the original account management platform and the new account management platform, the subscribing account of the user in the original account management platform and.

The resource management server 3002 may provide an operating interface for the user to choose, as is shown in FIG. 6. When selecting the new account management platform and requesting a resource reallocation, the user is prompted for a confirmation, and if the user taps a confirm button, subsequent resource reallocating and transferring operations are performed.

After receiving the resource reallocation instruction from the user terminal 3001, the resource management server 3002 deducts a specified quantity N of resources from the first management platform 3004 based on the account of the user terminal 3001 in the resource management server 3002, where N is not greater than M (the quantity of resources the user allocates to the first management platform 3004). To facilitate the deducting operation of the resource management server 3002, the resource management server 3002 may in advance bond an account registered by the user in the resource management server 3002 and a subscribing account of the user in the first management platform 3004.

Taking fund account management platforms for example, after receiving the resource allocation instruction from the user terminal 3001, the resource management server 3002 needs to complete switching between transaction accounts of the user and redeems shares in an original account from the original account management platform (the first management platform 3004), where the shares in the original account is obtained from the resource allocation instruction from the user terminal 3001.

The resource management server 3002 sends a redemption request for the shares in the original account to the original account management platform, and the original account management platform deducts the shares in the original account of the user in response to the redemption request from the resource management server 3002.

After deducting the specified quantity N of resources from the first management platform 3004 according to the resource reallocation instruction from the user terminal 3001, the resource management server 3002 notifies the payment server 3003 to perform a payment operation. The payment server 3003 pays a specified quantity of currencies from the payment account corresponding to the first management platform 3004 to the payment account corresponding to the second management platform 3005 according to a payment instruction of the resource management server 3002, where the specified quantity of currencies matches the specified quantity N of resources deducted by the resource management server 3002.

After completing the payment operation, the payment server 3003 returns payment success information to the resource management server 3002.

After the resource management server 3002 receiving the payment success information returned by the payment server 3003, the payment server 3003 notifies the second management platform 3005 of a payment success.

After receiving the payment success information, the second management platform 3005 adds resources matching the specified quantity of currencies to an account therein for the user terminal 3001.

In the solution according to the embodiment above, the resource management server 3002 obtains the resource reallocation instruction from the user terminal 3001, deducts the specified quantity of resources from the first management platform 3004 according to the resource reallocation instruction based on the account of the user terminal 3001, sends the payment instruction to the payment server 3003 for the payment server 3003 to pay the specified quantity of currencies from the payment account corresponding to the first management platform 3004 to the payment account corresponding to the second management platform 3005, where the specified quantity of currencies matches the specified quantity of resources, notifies the second management platform 3005 of the payment success after the payment server 3003 pays successfully, for the second management platform 3005 to add the resources matching the specified quantity of currencies to the account therein. In this way, operations of the user for reallocating resources in an account are simplified, the reallocation process is performed in a real-time manner, and a waiting time of the user in switching between accounts is reduced.

Further, if the user terminal 3001 does not have an account in the second management platform 3005 and the user needs to allocate resources in the first management platform 3004 to the second management platform 3005, only after opening an account in the second management platform 3005 can the user allocate the resources in the first management platform 3004 to the second management platform 3005, which is taken into consideration in the embodiment.

To be specific, after receiving the resource allocation instruction from the user terminal 3001, the resource management server 3002 issues an account opening request to the second management platform 3005. The second management platform 3005 opens a new account for the user in response to the account opening request as received, and thereafter returns information that opening of the new account is completed to the resource management server 3002.

Taking a fund account management platform for example, a specific account opening process thereof is described as follows.

First, the resource management server 3002 issues a new account opening request to the new account management platform (the second management platform 3005) according to the resource reallocation instruction. The new account management platform completes account opening in response to the new account opening request received, and returns information that opening of a new account is completed to the resource management server 3002.

Thereafter, the resource management server 3002 issues a pre-subscribing request to the new account management platform, and the new account management platform generates a new account subscription order in response to the pre-subscribing request received, returns the same to the resource management server 3002 and waits for deduction.

In the solution above, the resource management server 3002 opens the new account for the user terminal 3001 in the second management platform 3005 after receiving the resource reallocation instruction from the user terminal 3001. Thereafter, the resource management server 3002 deducts the specified quantity of resources from the first management platform 3004 according to the resource reallocation instruction, and sends the payment instruction to the payment server 3003. The payment server pays the specified quantity of currencies from the payment account corresponding to the first management platform 3004 to the payment account corresponding to the second management platform 3005, where the specified quantity of currencies matches the specified quantity of resources. After the payment server 3003 pays successfully, the resource management server 3002 notifies the second management platform 3005 of the payment success, and the second management platform 3005 adds the resources matching the specified quantity of currencies to the new account of the user. In this way, operations of the user for reallocating resources in an account are simplified, the reallocation process is performed in a real-time manner, and a waiting time of the user in switching between accounts is reduced.

Further, management and control operations are performed on the new account in the embodiment.

To be specific, after completing opening of the new account in the second management platform 3005, the resource management server 3002 locks the new account as opened in the second management platform 3005, to facilitate reallocation operations on the resources in the account.

Thereafter, after resources in the first management platform 3004 are allocated to the second management platform 3005, the resource management server 3002 unlocks the new account as locked.

Through the solution according to the embodiment above, flexible control and management of accounts and a flexible choice between different account management platforms are achieved for the user, operations of the user for reallocating resources in an account are simplified, the resource reallocation process is performed in a real-time manner, and a waiting time of the user in switching between accounts is reduced.

Further, after allocating resources in the account from the first management platform 3004 to the second management platform 3005 for the user terminal 3001, the resource management server 3002 returns a resource reallocation result to the user terminal 3001, for the user to know of a status of the resource allocation. An interface on the user terminal 3001, in which the resource reallocation result is received, may be as shown in FIG. 10.

The process of the solution according to the embodiment is described in detail in conjunction with FIG. 11 and taking transferring of shares in an account for example, where FIG. 11 is a schematic diagram of a specific process of transferring the shares in the account according to the embodiment of the invention.

As shown in FIG. 11, with the first management platform 3004 defined as an original account management platform A and the second management platform 3005 defined as a new account management platform B, the specific process of transferring the shares in the account according to the embodiment is described as follows, which includes steps S10 to S22.

In step S10, the user terminal 3001 sends a resource reallocation instruction to the resource management server 3002.

If the user selects the new account management platform B and wants to transfer shares in the original account management platform A to the new account management platform B, the user terminal 3001 sends the resource reallocation instruction to the resource management server, to request transferring of the shares in the account

In step S11, a new account is opened.

The resource management server 3002 sends an account opening request to the new account management platform B, and the new account management platform B opens the new account in response to the account opening request.

In step S12, the new account management platform returns account opening success information after opening the new account.

In step S13, the resource management server 3002 issues a pre-subscribing request to the new account management platform B.

In step S14, the new account management platform B returns a subscription order and waits for deduction.

In step S15, the resource management server 3002 locks the new account of the user.

In step S16, the resource management server 3002 redeems the shares in an original account from the original account management platform A.

In step S17, the original account management platform A returns redemption and deduction success information.

In step S18, the resource management server 3002 notifies the payment server 3003 to transfer the shares as redeemed of the original account to the new account.

In step S19, the payment server 3003 returns transfer success information to the resource management server.

In step S20, the resource management server 3002 notifies the new account management platform B of a payment success.

In step S21, the resource management server 3002 unlocks the new account.

In step S22, the resource management server 3002 returns share transfer success information to the user terminal.

Taking fund products of fund companies for example, the user owns fund shares of a fund company A, and if the user finds a fund product with more profits of another fund company B, the user can choose to transfer all already-owned shares to a product of a new fund company. All the user needs to do is to select the fund product to be transferred to and submit a share transfer request.

The resource management server 3002 opens an account in the fund company B to be transferred to and issues a pre-subscribing request at background, redeems all the fund shares owned by the user in the fund company A, transfers all money to an account of the company B and notifies the fund company B of a deduction completion. And then the fund company B adds shares for the user.

The whole operating process is performed synchronously, and the user can obtain a transfer result in a real-time manner without waiting until the money is credited into account and see own shares held in the fund product of the fund company B, which greatly reduces a waiting time of the user, improves user experience and increases profits of the user

Transferring of shares in accounts between different fund products of a same fund company may also be implemented through the solution according to the embodiment, which is not described herein redundantly.

In the method, server and system for reallocating resources in an account according to the embodiment of the invention, the resource management server 3002 obtains the resource reallocation instruction from the user terminal 3001, deducts the specified quantity of resources from the first management platform 3004 according to the resource reallocation instruction based on the account of the user terminal 3001, sends the payment instruction to the payment server 3003 for the payment server 3003 to pay the specified quantity of currencies from the payment account corresponding to the first management platform 3004 to the payment account corresponding to the second management platform 3005, where the specified quantity of currencies matches the specified quantity of resources, and notifies the second management platform 3005 of the payment success after the payment server 3003 pays successfully, for the second management platform 3005 to add the resources matching the specified quantity of currencies to the account therein. In this way, operations of the user for reallocating the resources in an account are simplified, the reallocation processed is performed in a real-time manner and a waiting time of the user in switching between accounts is reduced.

It should be noted that terms such as “include”, “comprise” or any other variant are meant to cover non-exclusive enclosure, so that the process, method, item or device comprising a series of elements not only includes the elements but also include other elements which are not listed explicitly or the inherent elements of the process, method, item and device. With no other limitations, the element restricted by the phrase “include a . . . ” does not exclude the existence of other same elements in the process, method, item or device including the elements.

Numberings of the embodiments according to the present disclosure are merely for a purpose of description, rather than representing merits of the embodiments.

According to the descriptions of the embodiments above, those in the art can clearly understand that the methods according to the embodiments above can be implemented with software plus a necessary general-purpose hardware platform, or with hardware, of course, where the former makes a better implementation on most occasions. Based on such understanding, the essence or the part making a contribution to conventional technology of the technical solutions according to the present disclosure can be implemented in the form of a computer software product. The computer software product may be stored in a storage medium (such as a ROM/RAM, a disk or an optical disc), and includes some instructions for a terminal device (such as a phone, a computer, a server or a network device) to implement the methods described in the embodiments according to the present disclosure.

The embodiments above are only some preferred embodiments of the invention, and are not intended to limit the scope of the invention. Any equivalent structures or flow transformations obtained based on the specification and the drawings according to the present disclosure and direct or indirect applications of the invention in other related technical fields shall fall within the scope of the invention.

1. A method for reallocating resources, comprising:
receiving a resource reallocation instruction from a terminal corresponding to a user, wherein the resource reallocation instruction carries an identifier of a first management platform, an identifier of a second management platform, a first amount of money required for purchasing resources and a first account identity registered by the user in the first management platform;
obtaining a second account identity of the user in the second management platform corresponding to the identifier of the second management platform;
transferring the first amount of money from a resource management account to an account corresponding to the second account identity, and requesting the second management platform to allocate the resources to the account corresponding to the second account identity based on the first amount of money; and
requesting the first management platform to transfer the first amount of money from an account corresponding to the first account identity to the resource management account based on the identifier of the first management platform.

2. The method according to claim 1, wherein the requesting the first management platform to transfer the first amount of money from an account corresponding to the first account identity to the resource management account based on the identifier of the first management platform comprises:
obtaining a third account identity bound with the first account identity and monitoring an account corresponding to the third account identity, wherein the third account identity is registered by the user in the resource management platform;
sending a deduction request to the first management platform based on the identifier of the first management platform, wherein the deduction request carries the first amount of money and the first account identity, for the first management platform to deduct the first amount of money from the account corresponding to the first account identity and transfer the first amount of money from the account corresponding to the first account identity to the account corresponding to the third account identity after the deducting is completed; and
transferring the first amount of money from the account corresponding to the third account identity to the resource management account on detecting that the first management platform transfers the first amount of money to the account corresponding to the third account identity.

3. The method according to claim 2, wherein the resource management instruction further carries a second amount of money required for purchasing resources and the method further comprises:
transferring the second amount of money from the account corresponding to the third account identity to the account corresponding to the second account identity, and requesting the second management platform to allocate the resources to the account corresponding to the second account identity based on the second amount of money.

4. The method according to claim 1, wherein the requesting the second management platform to allocate the resources to the account corresponding to the second account identity based on the first amount of money comprises:
sending a resource allocation request to the second management platform, wherein the resource allocation request carries a transfer instruction and the second account identity, wherein the transfer instruction is used to indicate a successful transfer of the first amount of money from the resource management account to the account corresponding to the second account identity, for the second management platform to allocate the resources to the account corresponding to the second account identity based on the first amount of money on receiving the transfer instruction.

5. The method according to claim 1, wherein the resource reallocation instruction further carries identity information of the user, and the obtaining a second account identity registered by the user in the second management platform corresponding to the identifier of the second management platform comprises:
sending a register request message to the second management platform based on the identifier of the second management platform, wherein the register request message carries the identity information of the user, for the second management platform to register the second account identity based on the identity information of the user; and
receiving the second account identity from the second management platform.

6. A server comprising a receiver and a processor, wherein,
the receiver is configured to receive a resource reallocation instruction from a terminal corresponding to a user, wherein the resource reallocation instruction carries an identifier of a first management platform, an identifier of a second management platform, a first amount of money required for purchasing resources and a first account identity registered by the user in the first management platform, and
the processor is configured to obtain a second account identity of the user in the second management platform corresponding to the identifier of the second management platform, transfer the first amount of money from a resource management account to an account corresponding to the second account identity, request the second management platform to allocate the resources to the account corresponding to the second account identity based on the first amount of money, and request the first management platform to transfer the first amount of money from an account corresponding to the first account identity to the resource management account based on the identifier of the first management platform.

7. The server according to claim 6, further comprising a transmitter, wherein,
in the case that the processor requests the first management platform to transfer the first amount of money from the account corresponding to the first account identity to the resource management account based on the identifier of the first management platform,
the processor is configured to obtain a third account identity bound with the first account identity and monitor an account corresponding to the third account identity, wherein the third account identity is registered in a resource management platform by the user;
the transmitter is configured to send a deduction request to the first management platform based on the identifier of the first management platform, wherein the deduction request carries the first amount of money and the first account identity, for the first management platform to deduct the first amount of money from the account corresponding to the first account identity and transfer the first amount of money from the account corresponding to the first account identity to the account corresponding to the third account identity after the deducting is completed; and
the processor is further configured to transfer the first amount of money from the account corresponding to the third account identity to an account corresponding to the resource server on detecting that the first management platform transfers the first amount of money to the account corresponding to the third account identity.

8. The server according to claim 7, wherein the resource reallocation instruction further carries a second amount of money required for purchasing resources, and
the processor is further configured to transfer the second amount of money from the account corresponding to the third account identity to the account corresponding to the second account identity, and request the second management platform to allocate the resources to the account corresponding to the second account identity based on the second amount of money.

9. The server according to claim 6, further comprising a transmitter, wherein,
in the case that the processor requests the second management platform to allocate the resources to the account corresponding to the second account identity based on the first amount of money, the processor is configured to:
trigger the transmitter to send a resource allocation request to the second management platform, wherein the resource allocation request carries a transfer instruction and the second account identity, wherein the transfer instruction is used to indicate that the first amount of money is successfully transferred from the resource management account to the account corresponding to the second account identity, for the second management platform to allocate the resources to the account corresponding to the second account identity based on the first amount of money on receiving the transfer instruction.

10. The server according to claim 6, wherein the resource reallocation instruction further carries identity information of the user and the server further comprises a transmitter, wherein,
in the case that the processor obtains the second account identity of the user in the second management platform corresponding to the identifier of the second management platform,
the processor is configured to trigger the transmitter to send a register request message to the second management platform based on the identifier of the second management platform, wherein the register request message carries the identity information of the user, for the second management platform to register the second account identity based on the identity information of the user; and
the receiver is further configured to receive the second account identity from the second management platform.

11. A method for reallocating resources, comprising:
obtaining, by a resource management server, a resource reallocation instruction from a user terminal, wherein the resource reallocation instruction comprises information of reallocation of resources in an account registered by the user terminal in the resource management server among a plurality of platforms, wherein the plurality of platforms comprise at least a first management platform and a second management platform, and a predetermined quantity M of the resources in the account is allocated to the first management platform;
deducting a specified quantity N of resources from the first management platform according to the resource reallocation instruction based on the account of the user terminal, wherein N is not greater than M;
sending a payment instruction to a payment server, wherein the payment instruction comprises paying a specified quantity of currencies from a payment account corresponding to the first management platform to a payment account corresponding to the second management platform, wherein the specified quantity of currencies matches the specified quantity N of resources; and
notifying, by the resource management server, the second management platform of a payment success after the payment server pays successfully, and adding, by the second management platform, in-account resources matching the specified quantity of currencies.

12. The method according to claim 11, wherein after the obtaining, by a resource management server, a resource reallocation instruction from a user terminal, the method further comprises:
sending, by the resource management server, a request instruction of opening a new account to the second management platform, for the second management platform to open a new account corresponding to the user terminal according to the request instruction.

13. The method according to claim 12, wherein after the second management platform opens the new account, the method further comprises:
locking, by the resource management server, the new account as opened.

14. The method according to claim 13, wherein after the payment server pays successfully, the method further comprising:
unlocking, by the resource management server, the new account.

15. The method according to claim 11, further comprising:
returning, by the resource management server, a resource reallocation result to the user terminal.

16. A server for reallocating resources, comprising:
an obtaining module, configured to obtain a resource reallocation instruction from a user terminal, wherein the resource reallocation instruction comprises information of reallocation of resources in an account registered by the user terminal in the resource management server among a plurality of platforms, wherein the plurality of platforms comprise at least a first management platform and a second management platform and a predetermined quantity M of the resources in the account is allocated to the first management platform;
a deducting module, configured to deduct a specified quantity N of resources from the first management platform according to the resource reallocation instruction based on the account of the user terminal, wherein N is not greater than M;
a requesting module, configured to send a payment instruction to a payment server, wherein the payment instruction comprises paying a specified quantity of currencies from a payment account corresponding to the first management platform to a payment account corresponding to the second management platform, wherein the specified quantity of currencies matches the specified quantity N of resources; and
a notifying module, configured to notify the second management platform of a payment success after the payment server pays successfully, for the second management platform to add in-account resources matching the specified quantity of currencies.

17. The server according to claim 16, further comprising:
an account opening module, configured to send a request instruction of opening a new account to the second management platform, for the second management platform to open a new account corresponding to the user terminal according to the request instruction of opening a new account.

18. The server according to claim 17, further comprising:
a locking module, configured to lock the new account as opened after the second management platform opens the new account.

19. The server according to claim 18, further comprising:
an unlocking module, configured to unlock the new account after the payment server pays successfully.

20. The server according to claim 16, wherein,
the notifying module is further configured to return a resource reallocation result to the user terminal.
